(19) United States
(12) Patent Application Publication
(10) Pub. No.: US 2025/0243851 A1
(43) Pub. Date: Jul. 31, 2025

(54) Cross-Spring Actuator Designs

(71) Applicant: Hutchinson Technology Incorporated, Hutchinson, MN (US)

(72) Inventor: Mark A. Miller, Hutchinson, MN (US)

(21) Appl. No.: 19/036,750

(22) Filed: Jan. 24, 2025

Related U.S. Application Data
(60) Provisional application No. 63/625,864, filed on Jan. 26, 2024.
(60) Provisional application No. 63/719,012, filed on Nov. 11, 2024.

(51) Int. Cl. F03G 7/06

(52) U.S. Cl. CPC F03G 7/06143

(57) ABSTRACT

The present embodiments relate to a cross-spring actuator (CSA) and device designs that incorporate one or more cross-spring actuators. The CSA can include a first cross-spring element and a second cross-spring element that each have end portions. The CSA can also include a set of spring arms connecting the first cross-spring element and the second cross-spring element. The set of spring arms can be disposed at an angle such that each of the set of spring arms cross at a pivot point. The CSA can also include at least one shape-memory alloy (SMA) wire connected between end portions of any of the cross-spring elements. The CSA can be part of a two-axis tilt module, a serial rotational joint, a spine device, and a revolute joint device.

### CROSS-REFERENCE TO RELATED APPLICATIONS

The present application claims priority to U.S. Provisional Patent Application No. 63/719,012, titled “CROSS-SPRING ACTUATOR DESIGNS,” and filed on Nov. 11, 2024, and U.S. Provisional Patent Application No. 63/625,864, titled “SHAPE MEMORY ALLOY TILT ACTUATOR USING CROSS SPRING PIVOTS,” and filed Jan. 26, 2024, the entire of which is incorporated by reference in its entirety herein.

### FIELD

The invention relates generally to an actuator, and more particularly, to an actuator with a cross spring pivot acts as an effective pivot location when an in-plane load is applied to one end to create a torque to cause an axis of rotation between a pivot location of the cross spring pivot.

### BACKGROUND

An actuator can be used in a variety of contexts. For example, an actuator can move a lens back and forth to focus the lens as part of an autofocus system or optical image stabilization system. In many cases, it can be desirable to move a moving component in a desired direction (e.g., a Z direction) to increase efficiency in implementing such systems.

However, many actuator designs may cause movement of the moving component in directions other than the desired direction. Such adverse motions can cause stress in the actuator, such as these forces adding unwanted torque and out of plane bending forces on the actuator. The desired motion can include rotation, and it may be desirable to prevent unwanted motion or translation about an unwanted axis due to unwanted flexing of the structure during actuation. Therefore, it is desirable for an actuator with a design that constrains unwanted movement (e.g., X, Y, Z) during pitch and yaw tilt of a payload.

### SUMMARY

The present embodiments relate to a cross-spring actuator (CSA) and device designs that incorporate one or more cross-spring actuators. The CSA can include a first cross-spring element and a second cross-spring element that each have end portions, wherein end portions of each of the first cross-spring element and the second cross-spring element are a length (L) from one another. The CSA can also include a set of spring arms connecting the first cross-spring element and the second cross-spring element. The set of spring arms can be disposed at an angle such that each of the set of spring arms cross at a pivot point. The CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point. The CSA can be part of a two-axis tilt module, a serial rotational joint, a spine device, and a revolute joint device.

In an example embodiment, a cross-spring actuator (CSA) is provided. The CSA can include a first cross-spring element and a second cross-spring element that each have end portions, wherein end portions of each of the first cross-spring element and the second cross-spring element are a length (L) from one another. The CSA can also include a set of spring arms connecting the first cross-spring element and the second cross-spring element. The set of spring arms can be disposed at an angle such that each of the set of spring arms cross at a pivot point. The CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point. Actuation of the at least two SMA wires can cause movements of the first or second cross-spring elements relative to the pivot point.

In some instances, the first cross-spring element and the second cross-spring element are flat or comprise a pair of forms bending the first cross-spring element and the second cross-spring element.

In some instances, the distance D is between 0.3 to 0.5 millimeters (mm), and wherein a tilt rotation range of the CSA is between ±4.8 and ±7.8 degrees, and wherein a maximum torque ranges between 0.2 and 9.2 Newton millimeter (N-mm).

In some instances, the length L is around 6 mm, and the distance D is around 0.4 mm, and wherein a tilt rotation range of the CSA is around ±16 degrees, and wherein a maximum torque ranges between 0.2 and 9.2 N-mm.

In some instances, the length L is around 60 mm, and the distance D is around 4 mm, and wherein a tilt rotation range of the CSA is around ±18 degrees, and wherein a maximum torque ranges between 2 and 92 N-mm.

In some instances, the CSA can include a flexible printed circuit (FPC) disposed between portions of each of the first cross-spring element and the second cross-spring element. The FPC can include two conductive layers that are each configured to electrically connect to each portion of the first cross-spring element and the second cross-spring element. In some instances, the FPC further comprises a series of pads to provide a current to the at least one SMA wire and cause rotation of the CSA upward or downward.

In some instances, any of the first and second cross-spring elements and the FPC are formed using tabbing that is removed subsequent to forming any of the first and second cross-spring elements and the FPC.

In some instances, the CSA includes two additional SMA wires that are each disposed at each side of the CSA to allow for two-direction actuation.

In some instances, the CSA is part of a two-axis tilt module. In some instances, four CSA actuators are disposed about each side of a tilt carriage of the two-axis tilt module to allow for pitch and yaw tilting of the two-axis tilt module.

In some instances, the CSA is part of a rotational joint device where three CSA actuators are connected in series.

In some instances, the CSA is part of a spine device where two or more CSA actuators are disposed in parallel with rigid spacers disposed between adjacent CSA actuators. In some instances, the spine device comprises one degree of freedom operation with parallel sides of the two or more CSA actuators disposed in parallel bending to provide pitch motion, and wherein two separate circuits provide positive and negative pitch motion. In some instances, the spine device comprises two degrees of freedom operation with parallel sides of the two or more CSA actuators disposed in parallel bending in phase and/or out of phase to provide pitch motion and roll motion, and wherein four separate circuits provide positive and negative pitch motion and roll motion.

In some instances, the CSA is part of a revolute joint device with two or more CSA actuators are disposed in series around a rotation center. In some instances, the revolute joint device comprises an outer coupler that rotates at ⅓ an angle of a full motion end of the revolute joint device and a middle coupler that rotates at ⅔ the angle of the full motion end. In some instances, multiple revolute joint devices are disposed in parallel by attaching fixed ends and free ends of each revolute joint devices.

In some instances, the CSA can include two SMA wires that can be controlled via a feedforward control method. In some instances, the feedforward control method includes implementing a model that compensates for hysteresis of the SMA wires. In some instances, the feedforward control method includes using a single delta power metric comprising a difference in power provided to each of the at least two SMA wires to control the at least two SMA wires, wherein the feedforward control method uses a hysteresis model to achieve a linear input vs. output control for bi-directional control of the SMA wires.

In another example method, a method for manufacturing a cross-spring actuator includes providing a first cross-spring element and a second cross-spring element that each have end portions, wherein end portions of each of the first cross-spring element and the second cross-spring element are a length (L) from one another. The method can also include connecting a set of spring arms to the first cross-spring element and the second cross-spring element, wherein the set of spring arms are disposed at an angle such that each of the set of spring arms cross at a pivot point. The method can also include connecting at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point.

In some instances, the method can also include bending the first cross-spring element and the second cross-spring element to form a pair of forms bending the first cross-spring element and the second cross-spring element.

In some instances, the method can also include disposing a flexible printed circuit (FPC) between portions of each of the first cross-spring element and the second cross-spring element.

In some instances, the method can also include forming the first and second cross-spring elements using a first tabbing, forming the FPC using a second tabbing, and removing the first tabbing and the second tabbing.

In another example, a two-axis tilt module is provided. The two-axis tilt module includes a fixed base, a tilt carriage configured to tilt along a yaw axis and a pitch axis, and a cross-spring actuator (CSA) connected to the tilt carriage.

The CSA can include a first cross-spring element and a second cross-spring element that each have end portions, wherein end portions of each of the first cross-spring element and the second cross-spring element are a length (L) from one another. The CSA can also include a set of spring arms connecting the first cross-spring element and the second cross-spring element, wherein the set of spring arms are disposed at an angle such that each of the set of spring arms cross at a pivot point. The CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point, wherein actuation of the at least one SMA wire causes movements of the first or second cross-spring elements relative to the pivot point.

In some instances, four CSA actuators are disposed about each side of the tilt carriage of the two-axis tilt module to allow for pitch and yaw tilting of the two-axis tilt module.

In another example, a rotational joint device is provided. The rotational joint device can include at least three cross-spring actuators (CSAs) connected in series. Each CSA can include a first cross-spring element and a second cross-spring element that each have end portions, wherein end portions of each of the first cross-spring element and the second cross-spring element are a length (L) from one another. Each CSA can also include a set of spring arms connecting the first cross-spring element and the second cross-spring element, wherein the set of spring arms are disposed at an angle such that each of the set of spring arms cross at a pivot point. Each CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point.

In some instances, spacers are disposed between the at least three CSAs to isolate separate electrical circuits.

In another example, a spine device is provided. The spine device can include two or more cross-spring actuators (CSAs) connected in parallel. Each CSA can include a first cross-spring element and a second cross-spring element that each have end portions, wherein end portions of each of the first cross-spring element and the second cross-spring element are a length (L) from one another. Each CSA can also include a set of spring arms connecting the first cross-spring element and the second cross-spring element, wherein the set of spring arms are disposed at an angle such that each of the set of spring arms cross at a pivot point. Each CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point.

The spine device can also include rigid spacers disposed between adjacent CSA actuators of the two or more CSAs.

In some instances, the spine device comprises one degree of freedom operation with parallel sides of the two or more CSA actuators disposed in parallel bending to provide pitch motion, and wherein two separate circuits provide positive and negative pitch motion.

In some instances, the spine device comprises two degrees of freedom operation with parallel sides of the two or more CSA actuators disposed in parallel bending in phase and/or out of phase to provide pitch motion and roll motion, and wherein four separate circuits provide positive and negative pitch motion and roll motion.

In another example, a revolute joint device is provided. The revolute joint device can include three CSA actuators are disposed in series around a rotation center. Each CSA can include a first cross-spring element and a second cross-spring element that each have end portions, wherein end portions of each of the first cross-spring element and the second cross-spring element are a length (L) from one another. Each CSA can also include a set of spring arms connecting the first cross-spring element and the second cross-spring element, wherein the set of spring arms are disposed at an angle such that each of the set of spring arms cross at a pivot point. Each CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point. Each CSA can provide around ±15 degrees of rotation.

In some instances, the revolute joint device comprises an outer coupler that rotates at ⅓ an angle of a full motion end of the revolute joint device and a middle coupler that rotates at ⅔ the angle of the full motion end.

In some instances, multiple revolute joint devices are disposed in parallel by attaching fixed ends and free ends of each revolute joint devices.

Other features and advantages of embodiments of the present invention will be apparent from the accompanying drawings and from the detailed description that follows.

### BRIEF DESCRIPTION OF THE DRAWINGS

Embodiments of the present invention are illustrated, by way of example and not limitation, in the figures of the accompanying drawings, in which like references indicate similar elements and in which:

FIGS. 1A-1B are illustrations of an example cross spring pivot according to some embodiments.

FIGS. 2A-2B are illustrations of construction options for a cross spring pivot according to some embodiments.

FIGS. 3A-3B illustrate example cross spring pivots and example crossing point locations of the pivots according to some embodiments.

FIG. 4 is an example cross spring pivot according to some embodiments.

FIGS. 5A-5C illustrate example 1-axis SMA tilt actuators with cross spring pivots according to some embodiments.

FIGS. 6A-6B illustrate an example stiffness of 1-axis cross spring tilt modules according to some embodiments.

FIGS. 7A-7B illustrate example 2-axis SMA tilt actuators with cross spring pivots according to some embodiments.

FIGS. 8A-8B illustrate forces for pitch axis tilt for 2-axis tilt actuators according to some embodiments.

FIGS. 9A-9B illustrate forces for yaw axis tilt for 2-axis tilt actuators according to some embodiments.

FIG. 10 illustrates an example 2-axis SMA tilt actuator with bimorph actuators according to some embodiments.

FIG. 11 illustrates an example 2-axis SMA tilt actuator with different push force locations according to some embodiments.

FIGS. 12A-12B illustrate forces with modules with different push force locations according to some embodiments.

FIGS. 13A-B illustrate a second example set of forces with modules with different push force locations according to some embodiments.

FIGS. 14A-B illustrate example 2-axis SMA tilt actuators with different push force locations according to some embodiments.

FIGS. 15A-B illustrate example orientation of cross spring pivots in an actuator according to some embodiments.

FIGS. 16A-C illustrate views of an example cross-spring actuator according to some embodiments.

FIGS. 17A-E illustrate views of an example formed cross-spring actuator according to some embodiments.

FIGS. 18A-C illustrate example views depicting variables of a cross-spring actuator according to some embodiments.

FIGS. 19A-D illustrate views of example performance characteristics for a cross-spring actuator according to some embodiments.

FIGS. 20A-C illustrate views of example actuator performance with a 6 mm length of the SMA wire according to some embodiments.

FIGS. 21A-C illustrate views of performance of a 10X actuator design according to some embodiments.

FIGS. 22A-B illustrate example views of a cross-spring actuator with a FPC according to some embodiments.

FIG. 23 is an example flow process for manufacturing a cross-spring actuator according to some embodiments.

FIGS. 24A-B illustrate views of an example cross-spring actuator with an extra SMA wire according to some embodiments.

FIGS. 25A-B illustrate views of an example two-tilt module with cross-sprint actuators according to some embodiments.

FIGS. 26A-B illustrate example serial rotational joints according to some embodiments.

FIGS. 27A-B illustrate views of an example spine device with cross-spring actuators according to some embodiments.

FIG. 28 illustrates a view of an example two-degree of freedom spine device with cross-spring actuators according to some embodiments.

FIGS. 29A-B illustrate views a spine device both at rest and in motion according to some embodiments.

FIGS. 30A-C illustrates example views of a revolute joint with cross-spring actuators according to some embodiments.

FIGS. 31A-B illustrate example views of a stacked 3S revolute joint device according to some embodiments.

FIG. 32 illustrates an example interaction between SMA wires and power inputs and opposing forces according to some embodiments.

FIG. 33 is an example graphical representation of a move step and power of SMA wires in a cross-spring actuator according to some embodiments.

FIG. 34 is an illustration depicting an example feedforward control process according to some embodiments.

FIGS. 35A-B illustrate views of a four-wire cross-spring actuator according to some embodiments.

### DETAILED DESCRIPTION

The present embodiments relate to an actuator that includes one or more cross spring pivots that can be disposed at different sides of the actuator to provide an axis of rotation between pivot locations of the cross spring pivots. The cross spring pivots can be connected at a first side to a base and at the other side to a tilt carriage to provide an axis of rotation. Each of the cross spring pivots can include a first element and a second element, wherein each of the first element and the second element comprise a first end, a second end, and an arm connecting the first end to the second end. First ends and second ends of the first element and the second element can be affixed to one another. Further, a crossing point of the arms for each of the first element and second element can include a pivot point for each cross spring pivot. The actuator can also include one or more bimorph actuators to cause movement of the tilt carriage.

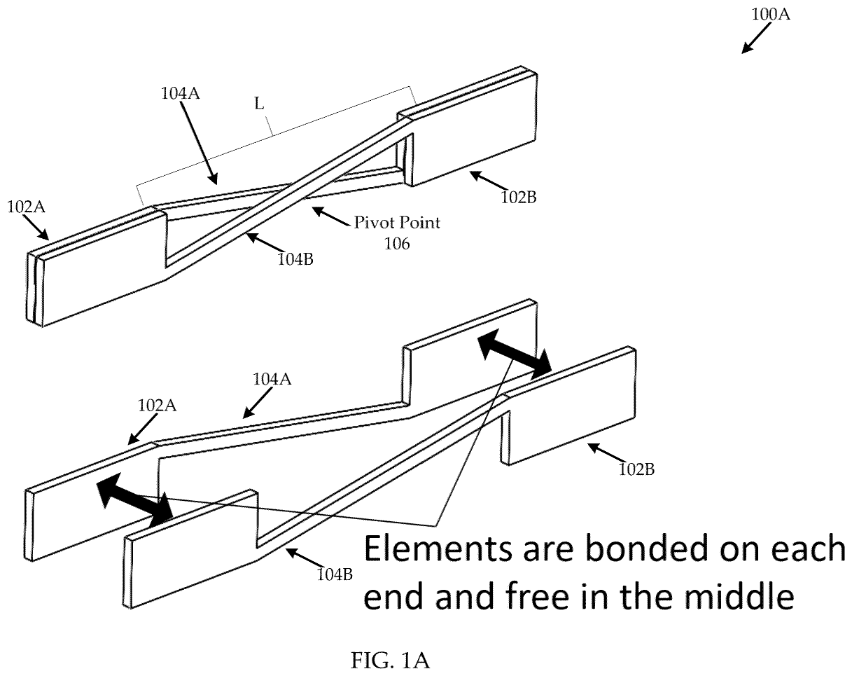

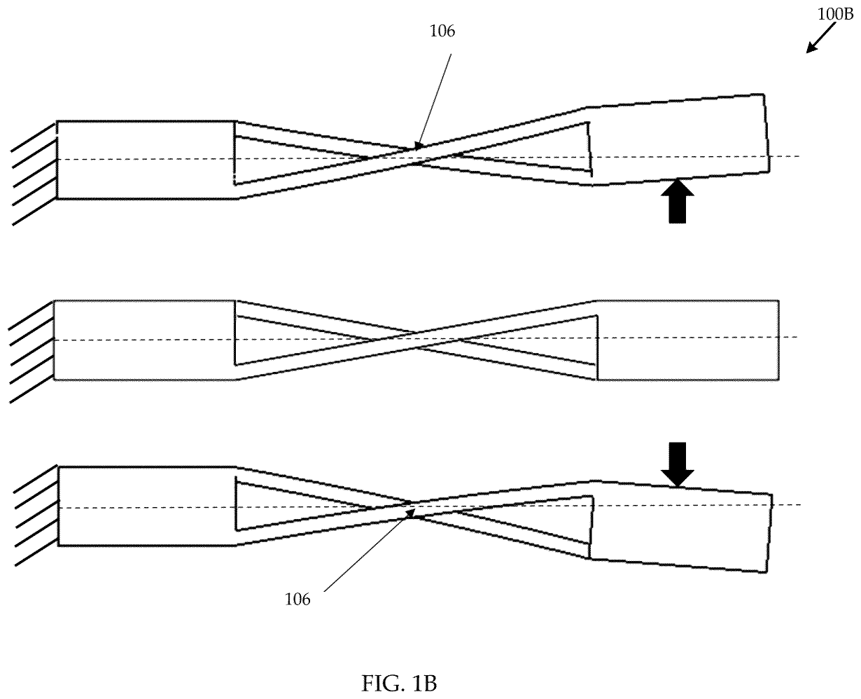

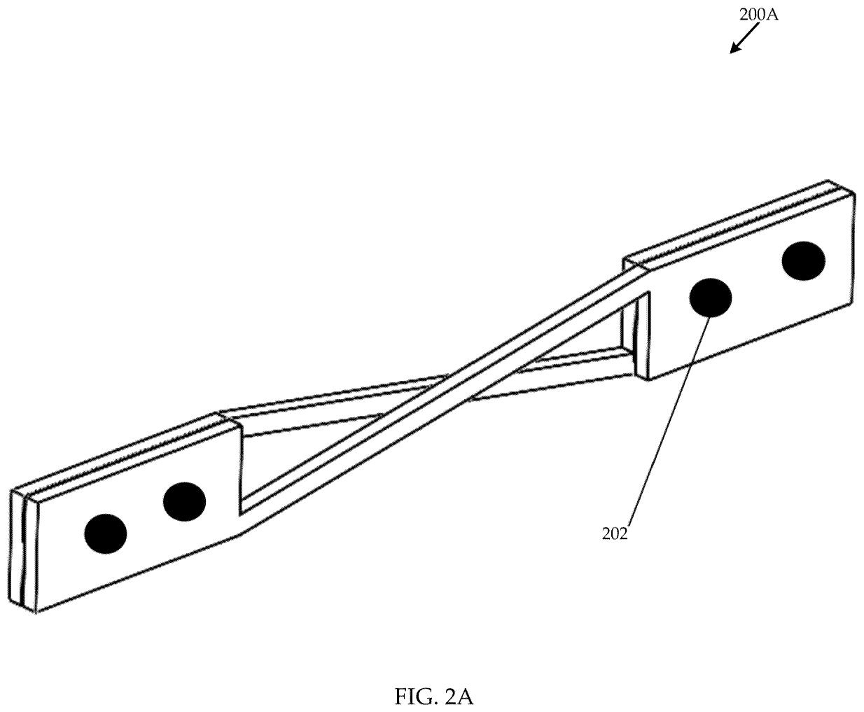

FIGS. 1A-1B are illustrations 100A-B of an example cross spring pivot. As shown in FIG. 1A, the cross spring pivot 100A can include a first element 102A and a second element 102B. Each element 102A-B can include arms 104A-B that extend between ends of each element. Further, elements can be bonded on each end and free in the middle.

Further, as shown in FIGS. 1A-1B, the design can include two or more elements with narrow arms that cross each other and are bonded to each other at ends of the elements and free in the middle where the elements cross. The location where the elements cross (e.g., pivot point 106) can act as an effective pivot location when an in-plane load is applied to one end to create a torque. A crossing point can be in the middle but can also be included at a point closer to one of the bonded ends. The thickness, width, length and angle of the crossing narrow arms can be factors in the bending stiffness of the pivot joint as well as the material.

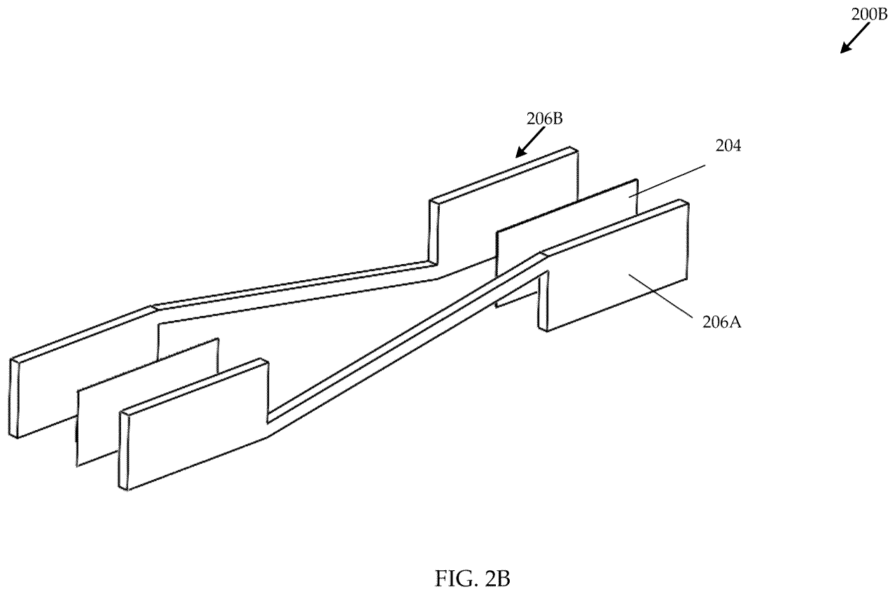

The cross spring pivot can have various construction options. FIGS. 2A-2B are illustrations 200A-B of construction options for a cross spring pivot. As shown in FIG. 2A, the cross spring pivot 200A can include a series of welds (e.g., 202) on one or both ends of the cross spring pivot to weld the ends together. Further, in FIG. 2B, the cross spring pivot 200B can include an adhesive or an insulator layer 204 that can fix ends of the cross spring pivot together. Further, the metal springs (e.g., 206A, 206B) can be electrically isolated to allow for additional conductive circuit paths.

In some instances, an example construction of the cross spring pivot can include bonding of the two ends of the cross spring pivots by any of welding the two sides together (e.g., Laser, resistance, wobble), using an adhesive to bond together, adding an insulative layer such as Kapton with adhesive layers applied to both sides between the pivots, building the elements from a laminate sheet of metal, insulator, metal (e.g., Steel, polyimide). In some instances, this can include a metal etch the shape of both sides and then remove the exposed insulator layer through plasma or wet etching. The small crossing area (pivot) could be etched long enough to fully remove the insulator from both metal springs at that location.

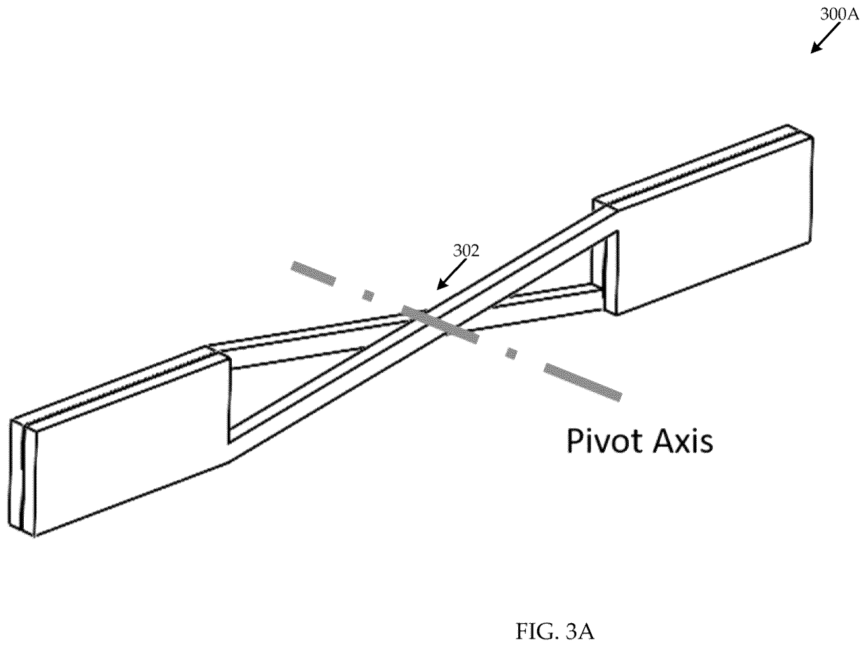

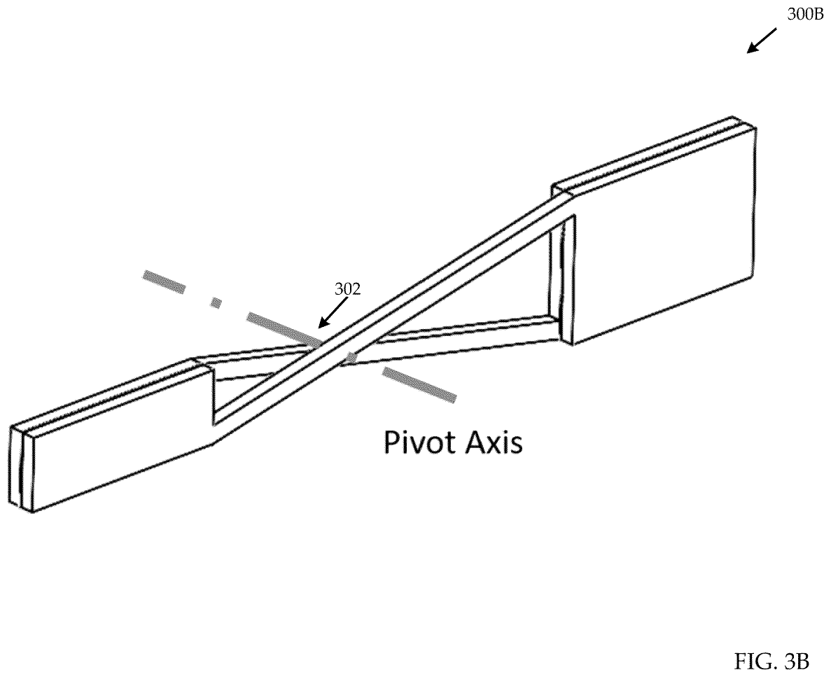

The cross spring pivot can include a crossing point location at a position between the arms of the elements. FIGS. 3A-3B illustrate example cross spring pivots 300A-B and example crossing point locations of the pivots. The effective pivot location can be located at the point 302 where the two or more elements cross. As shown in FIGS. 3A-3B, the crossing point can be in the middle (e.g., in FIG. 3A) or any location between the two ends of the elements (e.g., off-center as in FIG. 3B).

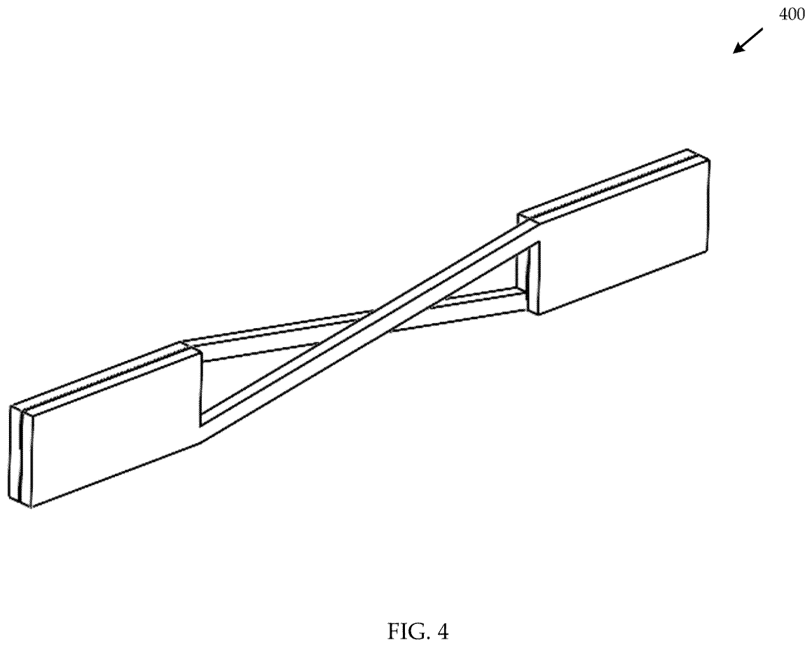

FIG. 4 is an example cross spring pivot 400. The cross spring pivot can have multiple benefits. For instance, the cross spring pivot can have a simple design to create pivot using as little as two components and can be miniaturized. The design may have no backlash or slop due to tolerances like in other hinges. The design may also have little or no hertzian contact stress wearing out the pivot like other hinges.

The designs can work well for applications that may require limited ranges of tilt rotation. The metal cross spring pivots can also be used to run electrical current through them to electrical devices in the tilt module. Out of plane stiffness can be relatively high compared to the in-plane pivot stiffness which can minimize any unwanted motion. The cross spring pivots can have its own return or centering spring built in.

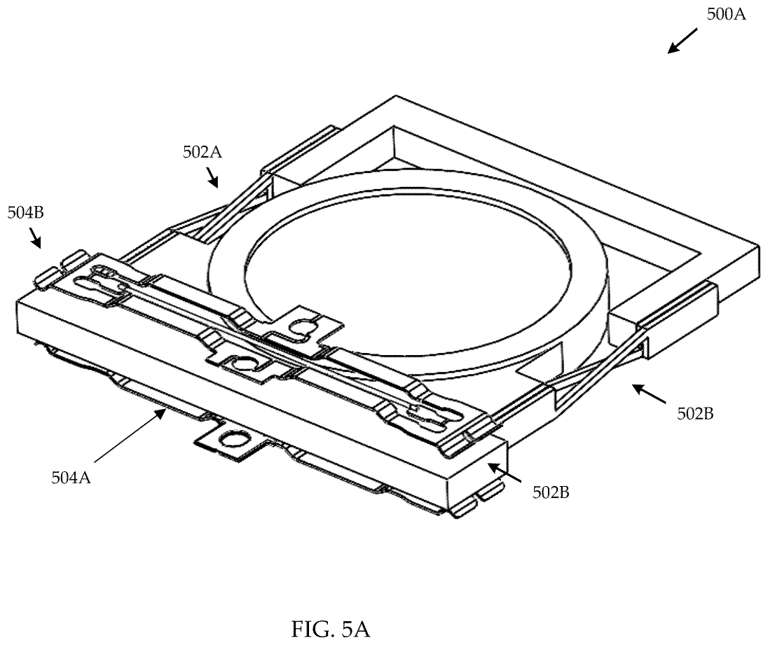

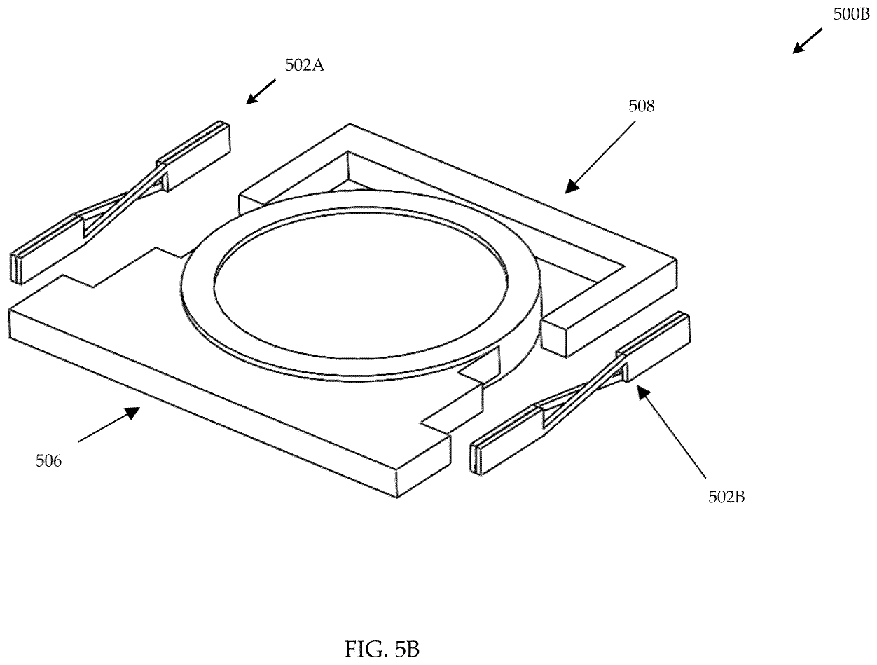

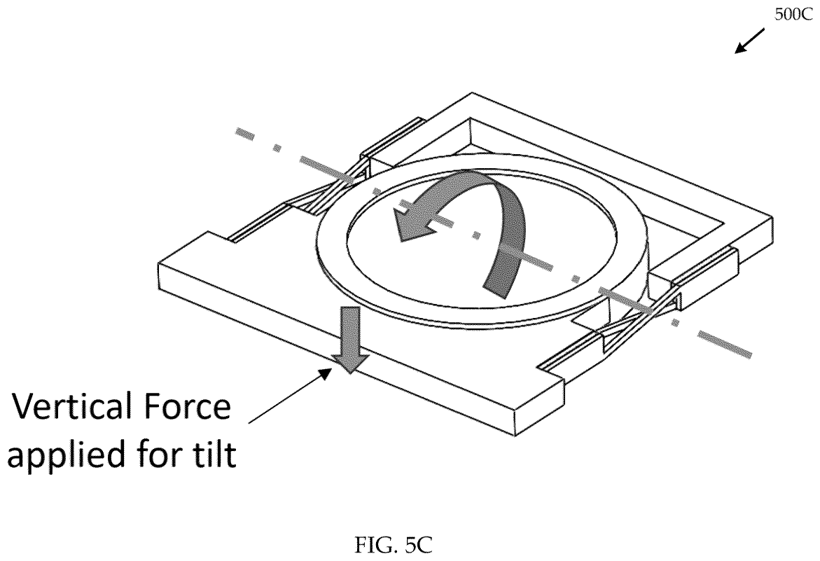

In a first example, a 1-axis shape memory alloy (SMA) tilt actuator with cross spring pivot can be implemented. FIGS. 5A-5C illustrate example 1-axis SMA tilt actuators 500A-C with cross spring pivots. As shown in FIG. 5A, the module can include cross spring pivots 502A-B and SMA bimorph actuators 504A-B. For example, the module can include a first bimorph actuator 504A pushing upward and a second bimorph actuator 504B pushing downward.

In FIGS. 5A-5C, the cross spring pivots can be attached to a fixed base 508 and a tilt carriage 506 at opposite sides as shown. A tilt motion range of ±5° or more can be available in each axis. Further, a vertical load applied to the tilt carriage can cause it to rotate about an axis that runs through the pivot points of the two cross spring pivots. Two or more SMA actuators can be positioned on either side of the tilt carriage to provide upward and downward forces for tilt motion. In some instances, two or more SMA actuators can be disposed on a single side of the tilt carriage 506.

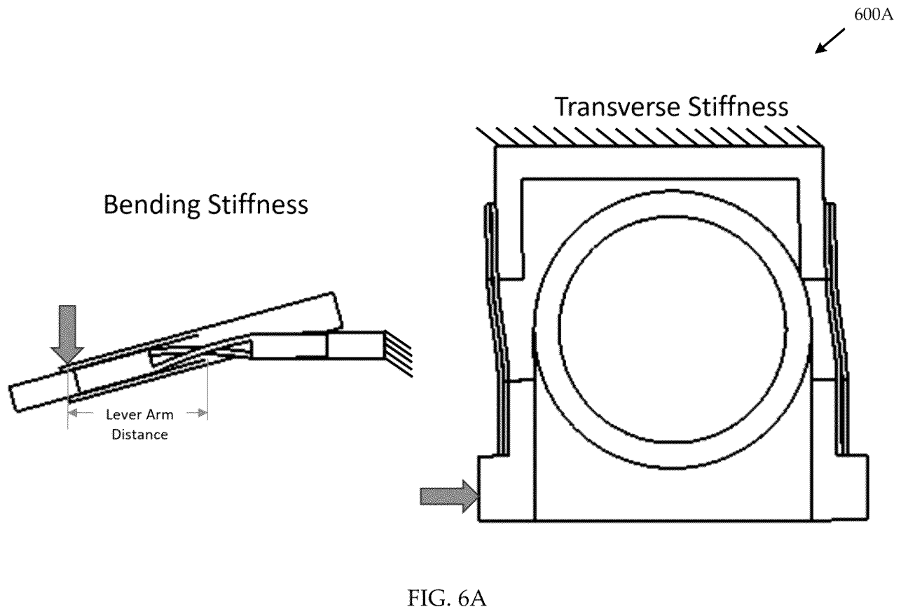

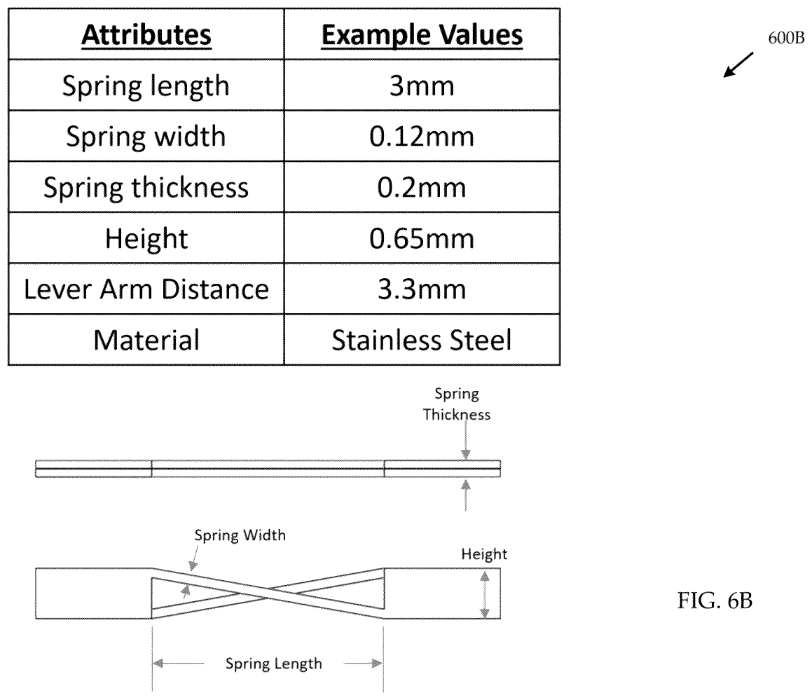

FIGS. 6A-6B illustrate an example stiffness of 1-axis cross spring tilt modules 600A-B. As shown in FIGS. 6A-6B, the bending stiffness of the module can be based on a lever arm distance of the cross spring pivots. Further, a traverse stiffness of the module can be dependent of the configuration of the cross spring pivots, such as a spring thickness, spring length, spring width, element height, and material (e.g., steel).

A bending stiffness can be around 420 n/m. The bending stiffness can be tailored per application with adjustments to cross spring attributes shown in the table in FIG. 6B. A desired bending stiffness could range between 10 n/m-1000 n/m, and a transverse stiffness can be around 6400 n/m (15 times higher than bending). The two cross spring pivots located on opposite sides of the tilt module can have high transverse stiffness to resist unwanted motion.

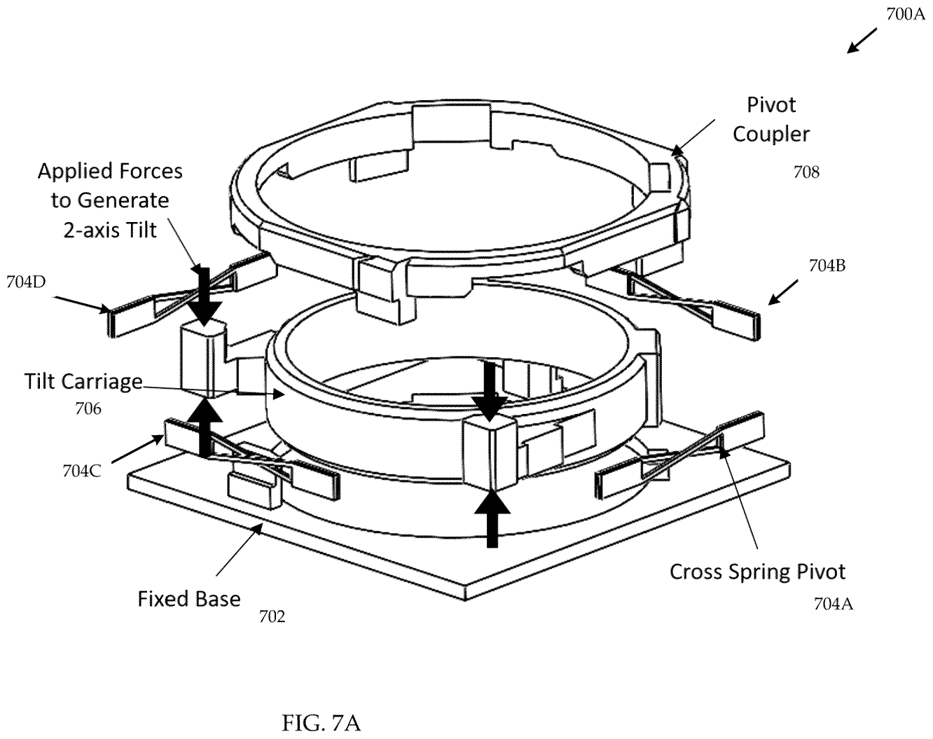

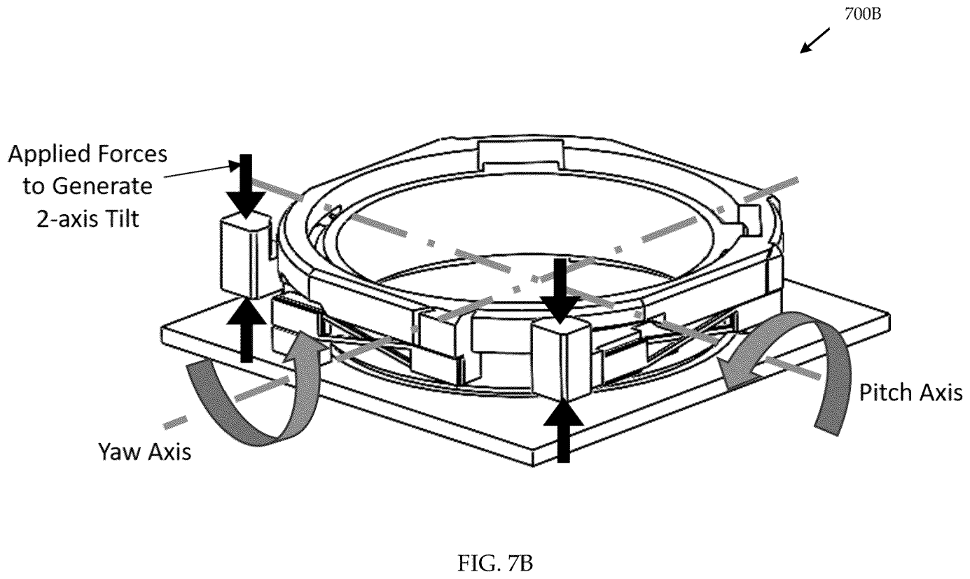

Another example design can include a 2-axis SMA tilt actuator with cross spring pivots. FIGS. 7A-7B illustrate example 2-axis SMA tilt actuators 700A-B with cross spring pivots. For instance, as shown in FIG. 7A, the actuator 700A can include a fixed base 702, a set of cross spring pivots (e.g., 704A-D), a tilt carriage 706, and a pivot coupler 708.

In a first example, four cross spring pivots can be attached around the perimeter of the module to allow 2-axis of rotation (pitch and yaw) to the tilt carriage. Tilt motion can range around ±5° or more in each axis. Further, a pair of opposite side cross pivot springs can have one end attached to the fixed base that can control yaw axis tilt. The other pair of opposite side cross pivot springs can have one end attached to the tilt carriage that can control pitch axis tilt.

One end of all 4 cross spring pivots can be attached to a pivot coupler component. Yaw tilt pivots can be attached between fixed base and pivot coupler. Pitch tilt pivots can be attached between coupler and tilt carriage. The pivot coupler and tilt carriage can have a clearance between them to allow free tilt motion. The pivot coupler tilts in 1-axis relative to the fixed base, and the tilt carriage tilts in 1-axis relative to the pivot coupler. The tilt carriage can tilt in two axes relative to the fixed base.

Actuators can apply opposing forces to the tilt carriage on one side of the pitch axis and opposite sides of the yaw axis. This arrangement can allow for full tilt motion along any desired tilt direction (pitch, yaw, corners and any direction in-between) by the application of ±forces at two locations to the tilt carriage.

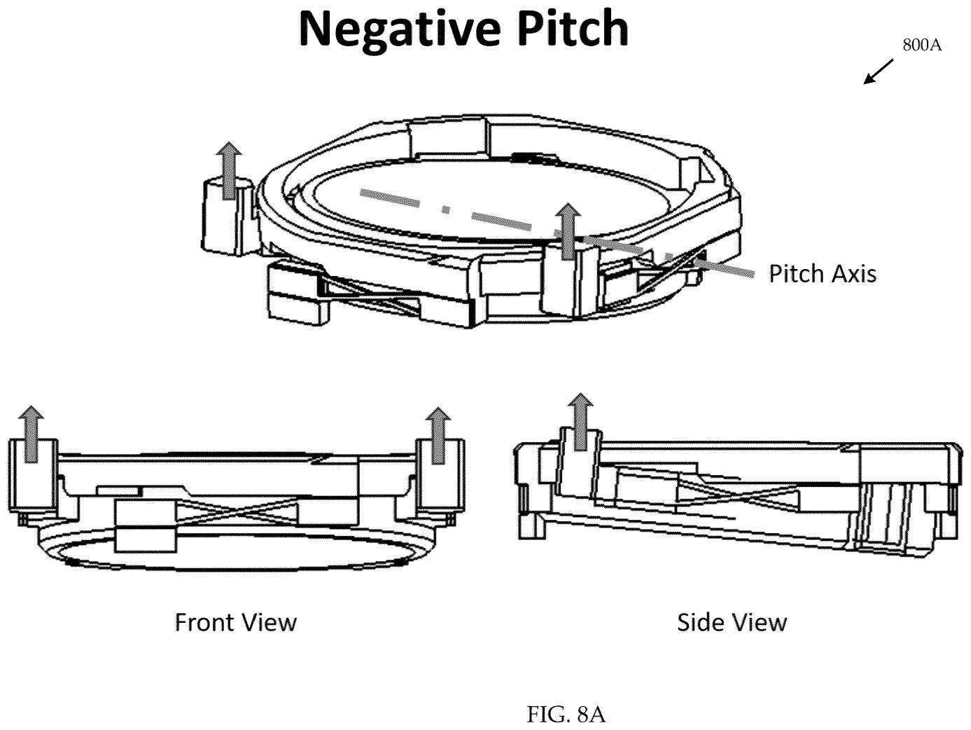

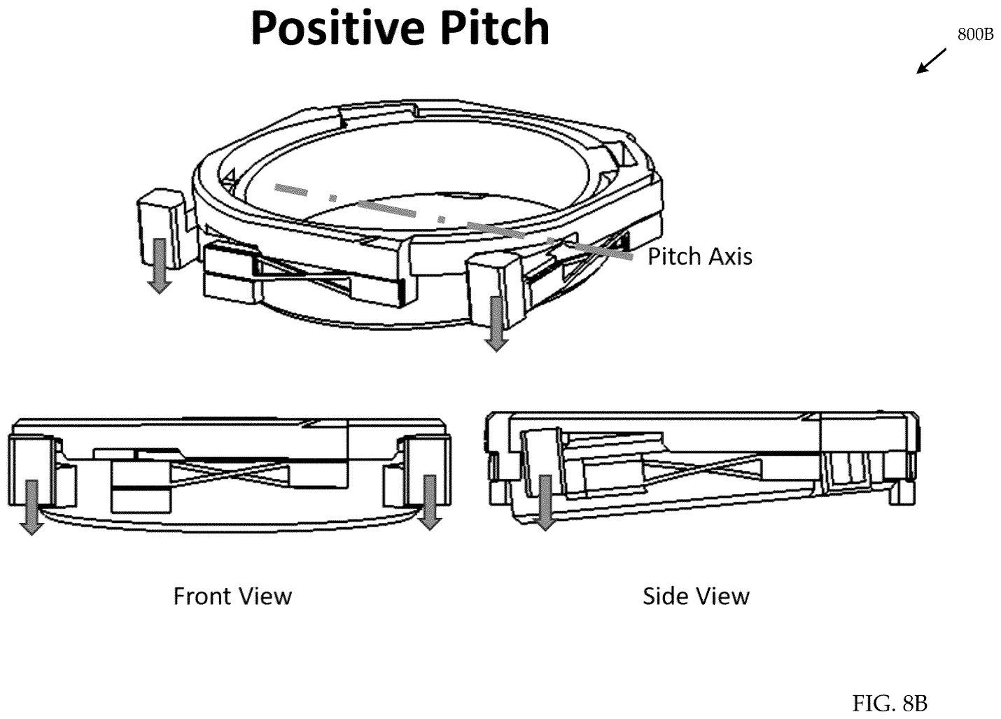

FIGS. 8A-8B illustrate forces for pitch axis tilt for 2-axis tilt actuators 800A-B. As shown in FIGS. 8A-8B, equal force can be applied at two locations that are the same distance from and same side as the pitch axis. As shown in FIGS. 8A-8B, the forces applied can be shown by arrows relative to a pitch axis.

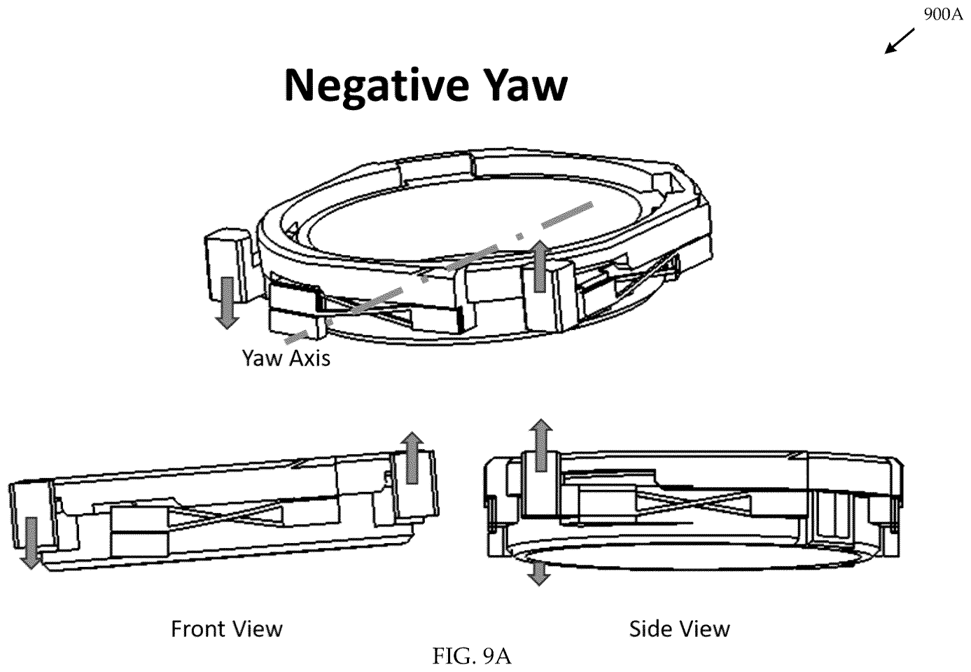

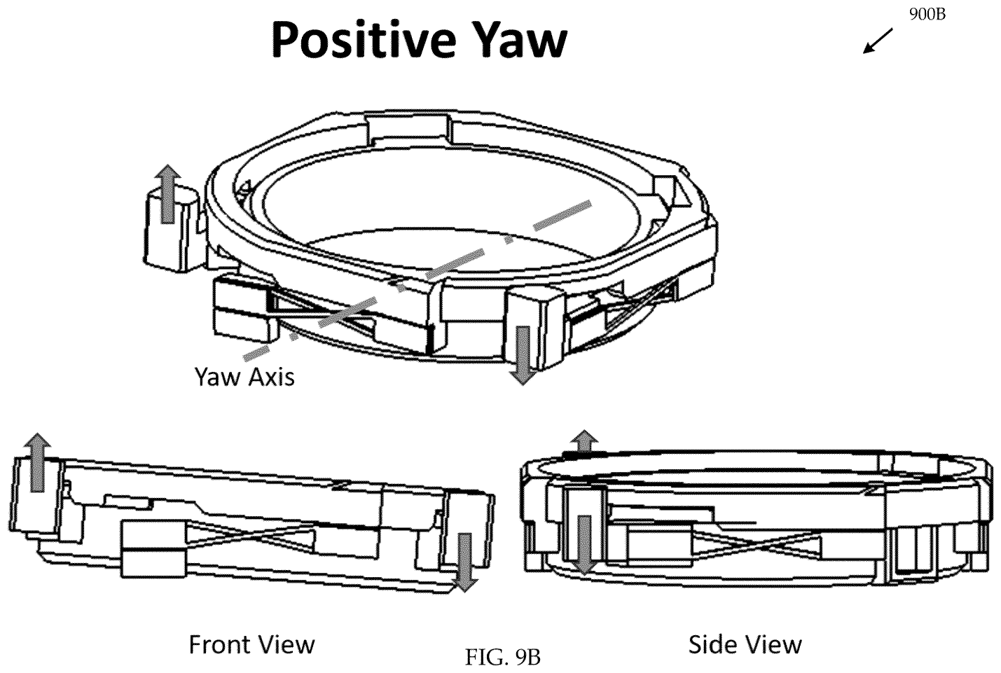

FIGS. 9A-9B illustrate forces for yaw axis tilt for 2-axis tilt actuators 900A-B. As shown in FIGS. 9A-9B, equal and opposite force can be applied at the two locations that are the same distance from and opposite side as the yaw axis.

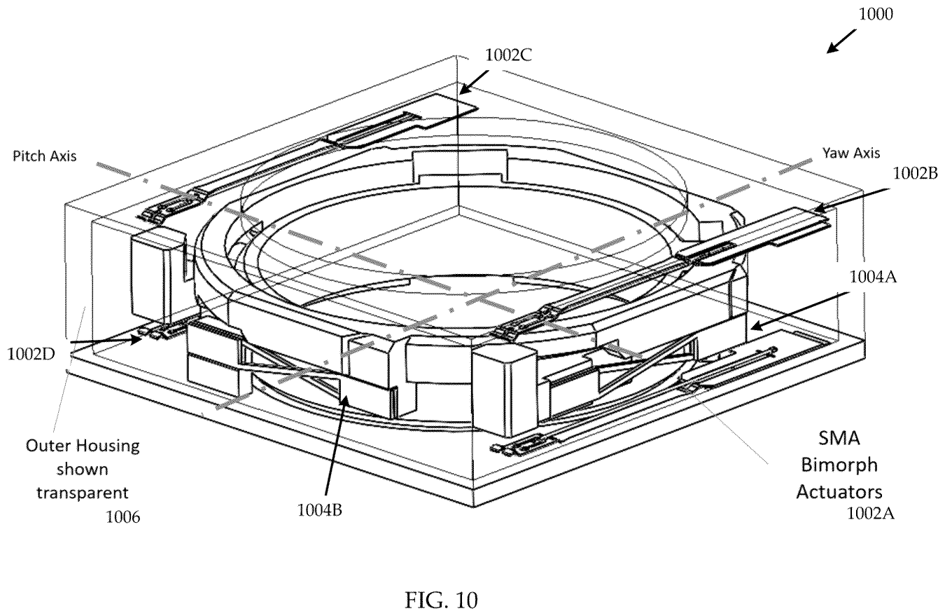

FIG. 10 illustrates an example 2-axis SMA tilt actuator 1000 with bimorph actuators. As shown in FIG. 10, four bimorph actuators 1002A-D can be applied to generate the required forces for 2-axis tilt motion. This can include two bimorph actuators on top pushing down and two bimorph actuators on bottom pushing upward. Actuators apply opposing forces to the tilt carriage on one side of the pitch axis and opposite sides of the yaw axis. The actuator can also include an outer housing 1006 and multiple cross spring pivots 1004A-B.

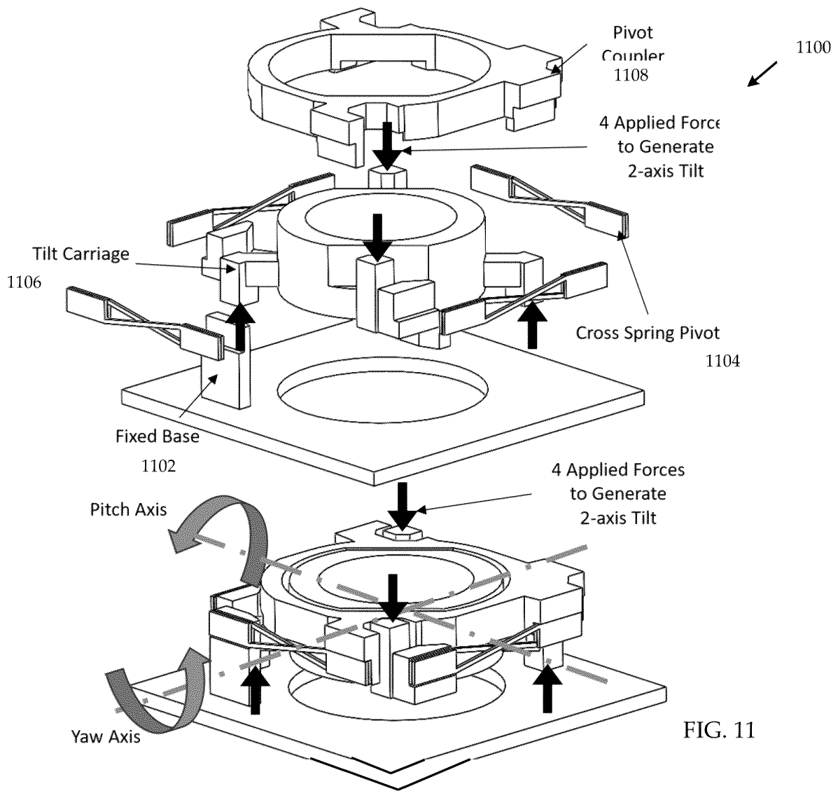

In some instances, a 2-axis SMA tilt actuator with cross spring pivots can have different push force locations. FIG. 11 illustrates an example 2-axis SMA tilt actuator 1100 with different push force locations. As shown in FIG. 11, the actuator can include a fixed base 1102, one or more cross spring pivots (e.g., 1104), a tilt carriage 1106, and a pivot coupler 1108. Further, multiple applied forces (e.g., as shown by arrows) can by applied to generate a 2-axis tilt.

In FIG. 11, four cross spring pivots can be attached around the perimeter of the module to allow 2-axis of rotation (pitch and yaw) to the tilt carriage. Tilt motion can range around ±5° or more in each axis. Further, a pair of opposite side cross pivot springs can have one end attached to the fixed base that can control yaw axis tilt. The other pair of opposite side cross pivot springs can have one end attached to the tilt carriage that can control pitch axis tilt.

One end of the four cross spring pivots can be attached to a pivot coupler component. Yaw tilt pivots can be attached between fixed base and pivot coupler and pitch tilt pivots can be attached between coupler and tilt carriage. The pivot coupler and tilt carriage can have clearance to allow for free tilt motion. The pivot coupler can tilt in 1-axis relative to the fixed base, and the tilt carriage can tilt in 1-axis relative to the pivot coupler. Therefore, the tilt carriage can tilt in 2-axis relative to the fixed base.

Actuators can apply opposing forces to the tilt carriage on opposite sides of the pitch axis and opposite sides of the yaw axis. The module can include two actuators from the top and two actuators from the bottom. The forces can be shown in corners of module, but the four forces could all be rotated together ±45° about the center vertical axis and provide full 2-axis tilt. This can allow for design flexibility. This arrangement can allow for full tilt motion along any desired tilt direction (pitch, yaw, corners and any direction in-between) by the correct application of ±forces at 4 locations to the tilt carriage.

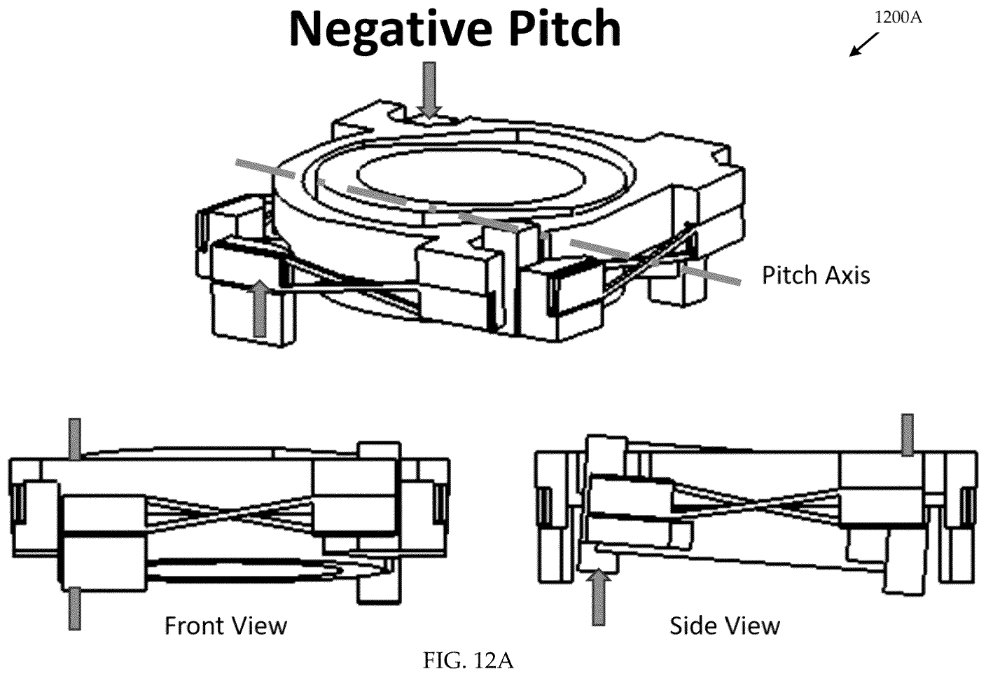

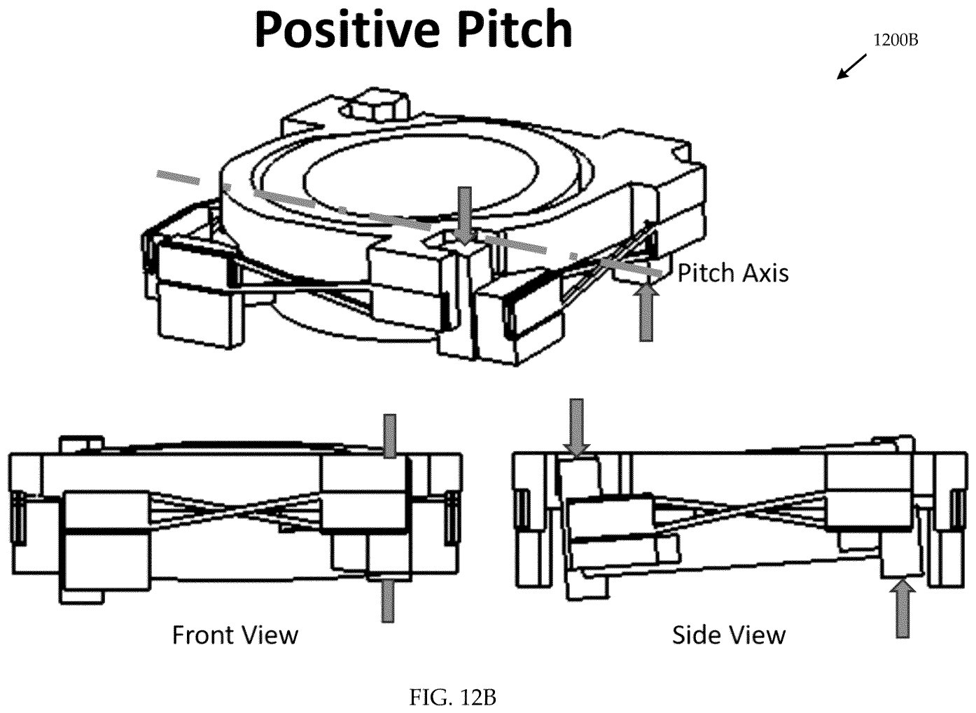

In another example embodiment, forces for pitch axis tilt for a 2-axis tilt module can have different push force locations. FIGS. 12A-12B illustrate forces with modules 1200A-B with different push force locations. Equal and opposite force can be applied at two locations that are on opposite sides and equal distance from the pitch axis. Further, the locations can change if it is negative verses positive pitch.

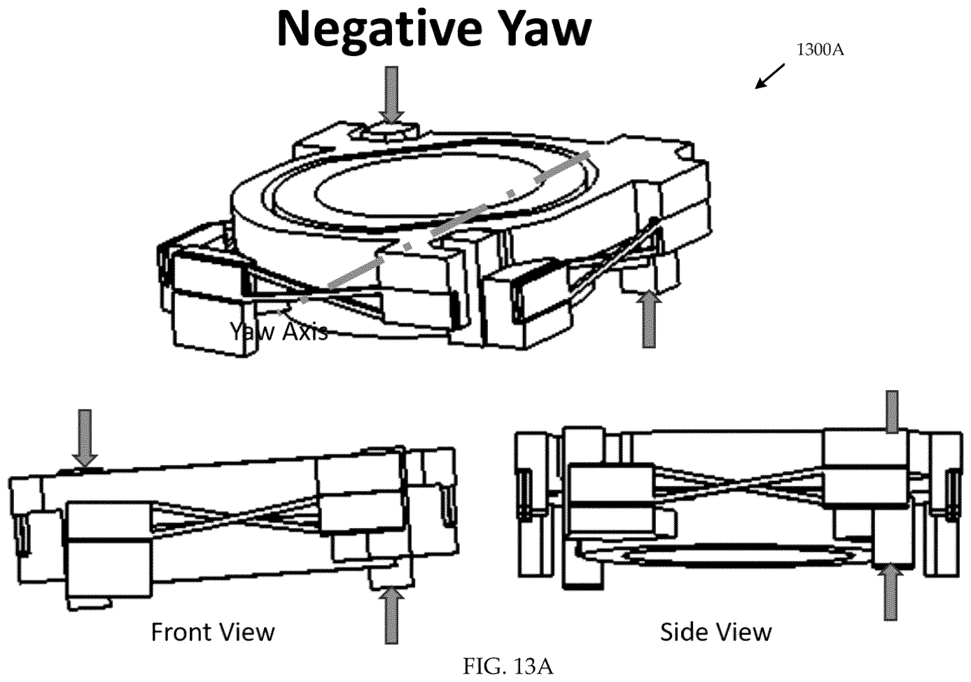

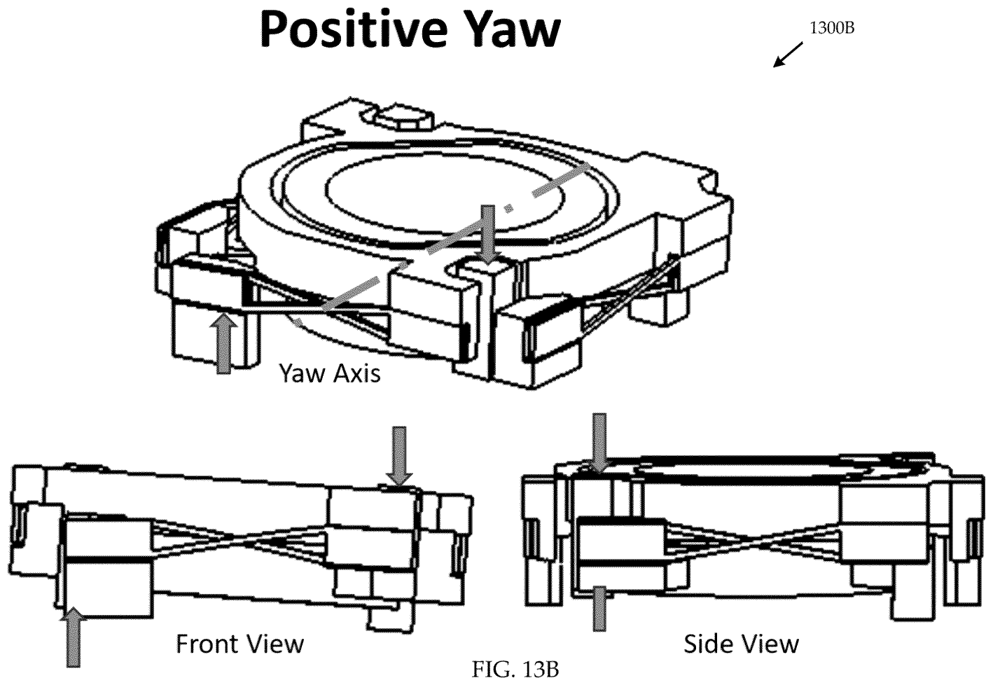

In another example embodiment, forces for yaw axis tilt for 2-axis tilt modules can have different push force FIGS. 13A-B illustrate a second example set of forces with modules 1300A-B with different push force locations. Equal and opposite force can be applied at two locations that are on opposite sides and equal distance from the yaw axis. The two locations can change if it is negative verses positive yaw.

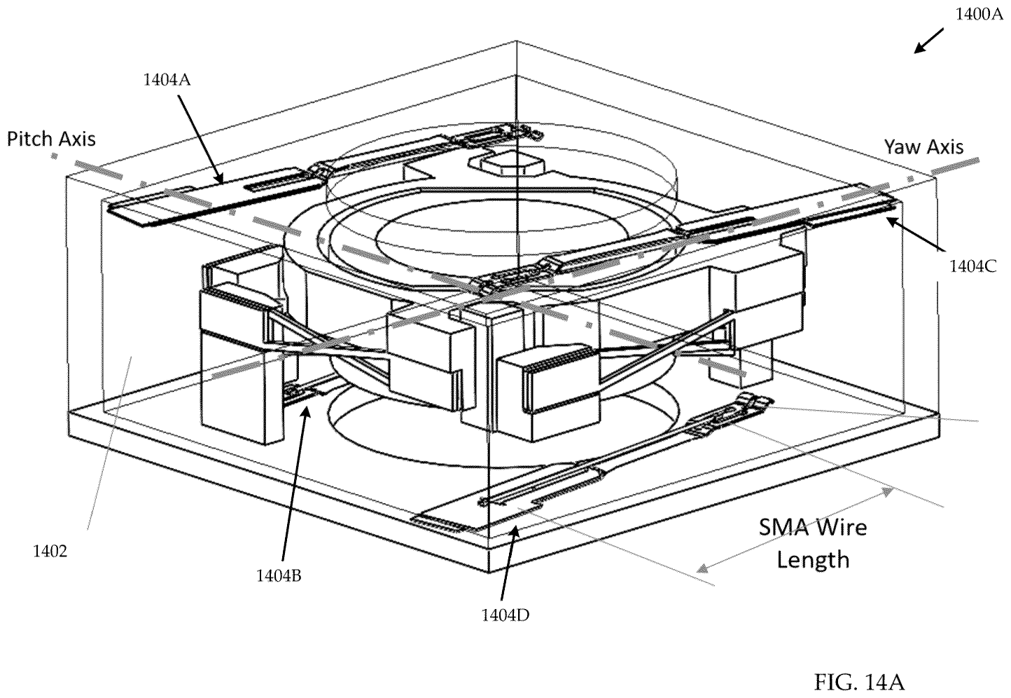

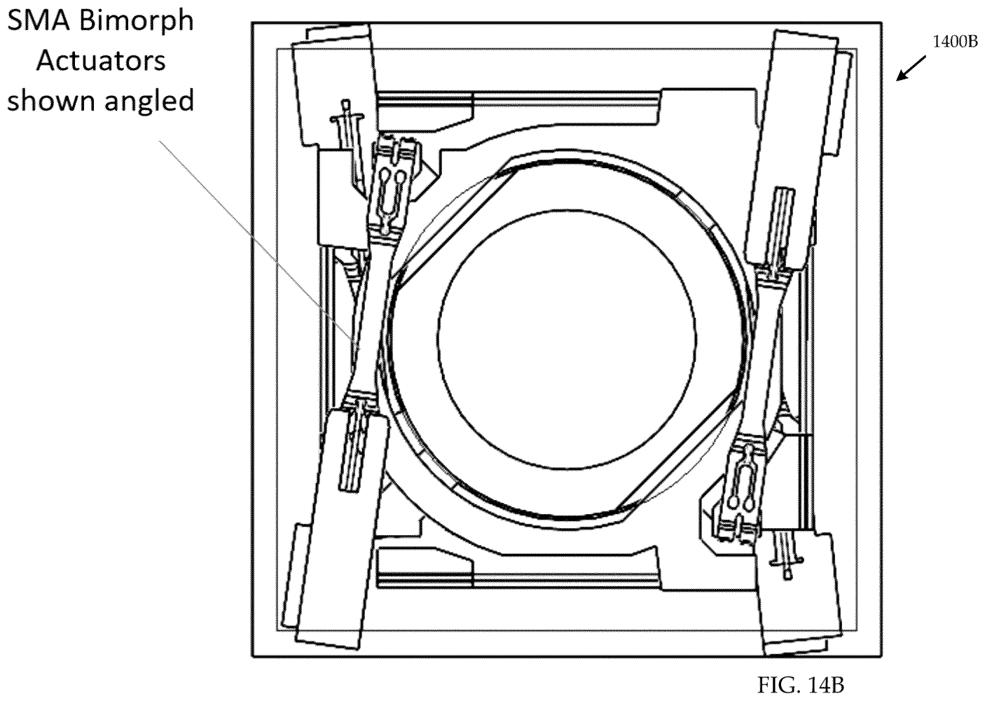

In another example, a 2-axis SMA tilt actuator with bimorph actuators can have different push force locations. FIGS. 14A-B illustrate example 2-axis SMA tilt actuators 1400A-B with different push force locations. The actuators can include four bimorph actuators 1404A-D applied to generate the required forces for 2-axis tilt motion within an outer housing 1402, with two actuators (e.g., 1404A, 104C) on top pushing down and two actuators on the bottom (e.g,. 1404B, 1404D) pushing upward. The actuators can apply opposing forces to the tilt carriage on opposite sides of the pitch axis and opposite sides of the yaw axis. This option shows them pushing in the corners which can allow for longer SMA wire length for more vertical stroke. The SMA actuators can be angled for clearance to tilt motion and to push closer to the center of rotation (which may require less vertical stroke per degree of rotation).

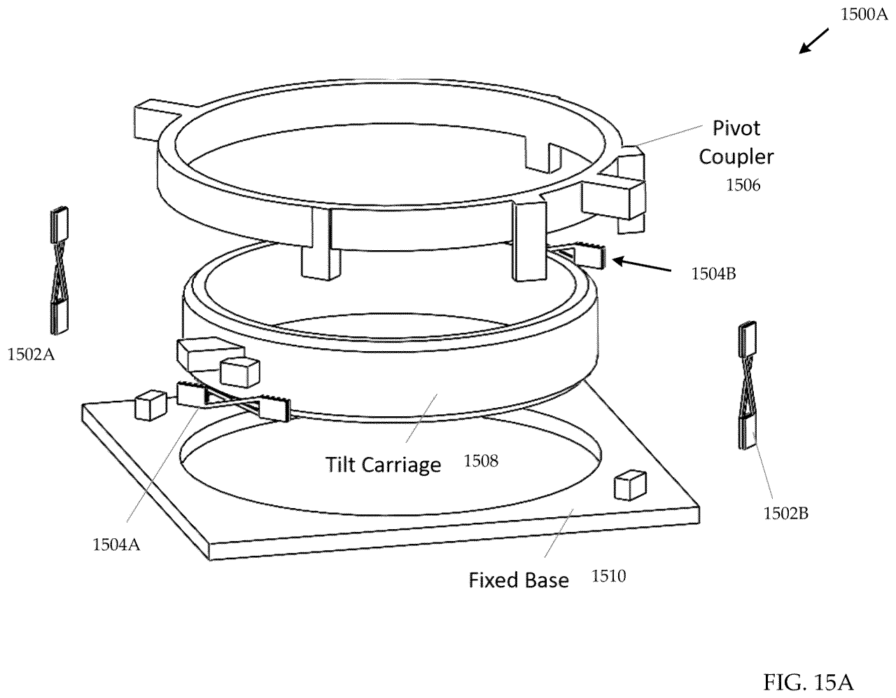

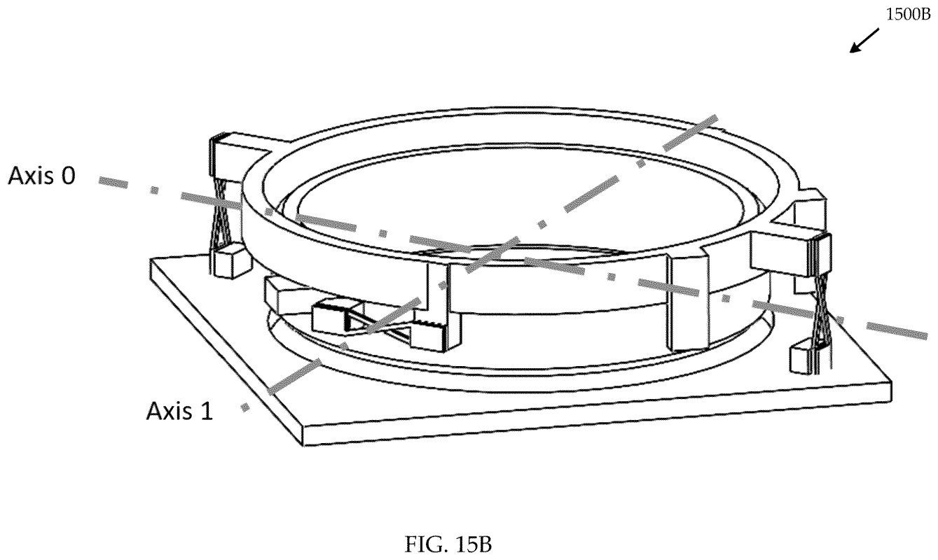

The orientation of the cross spring pivots can be shown in FIGS. 15A-B. Cross spring pivots can be orientated in any direction about their effective pivot location. They can be horizontal, vertical or at any angle. In the embodiment as shown in FIG. 15, the design 1500A can illustrate one axis having the pair of cross spring pivots 1502A-B being vertical and the other pair 1504A-B being horizontal. The design 1500A can also include a pivot coupler 1506, a tilt carriage 1508, and a fixed base 1510. In some instances, cross spring pivots can be positioned in the four corners of the module instead of on the sides and tilt carriage will still be able to tilt in all direction. This can allow for flexibility of design as other components can then be positioned on the sides.

The present embodiments relate to designs for a cross spring pivot built from as little as two or more flat components which are attached at their ends to each other and free in the middle. The embodiments also include methods for applying two cross spring pivots on two sides of a tilt carriage with one of their ends fixed to the tilt carriage and the other fixed to a static base to create an axis of rotation between the two pivot locations of the two cross spring pivots. This can include using two or more SMA bimorph actuators to apply opposing forces to the tilt carriage to generate positive and negative tilt about this axis of rotation. In some instances, applying the cross spring pivots can also include using angled SMA wire attached the tilt carriage to apply opposing forces to generate tilt or adding a permanent magnet to the tilt carriage and then using negative and positive current through a VCM coil to apply forces to the tilt carriage to generate tilt.

In some instances, applying the cross spring pivots can include applying four cross spring pivots that all have one of their ends attached to a spring coupler on four sides. Two opposite side cross spring pivots can have a second end attached to a tilt carriage. The other two opposite side cross spring pivots have a second end attached to a static base. This can create two axis of rotation through the pivot locations of the opposing cross spring pivots.

In some instances, four or more SMA bimorph actuators can be used to apply opposing forces to the tilt carriage to generate positive and negative tilt about two axis of rotation. Angled SMA wire attached the tilt carriage can be used to apply opposing forces to generate two axis tilt. In some instances, two permanent magnets can be added to the tilt carriage and then a negative and positive current can be applied through the two VCM coils to apply forces to the tilt carriage to generate two axis tilt.

The module can also include a motion control structure that uses hall element(s) and magnet(s) on tilt carriage to sense motion of the tilt carriage. In some instances, the motion control structure can use TMR element(s) and magnet(s) on tilt carriage to sense motion of the tilt carriage. In some instances, the motion control structure can use resistance or voltage of the SMA wires to determine position of the tilt carriage. In some instances, the motion control structure can use the measurement of capacitance between metal plates at various locations on the tilt carriage relative to metal plates on the static base to determine tilt angle of the carriage.

As noted above, a bimorph actuator can be used to actuate a moving carriage or lens carriage as described herein. According to various embodiments, a bimorph actuator includes a beam and one or more SMA materials such as an SMA ribbon or SMA wire the SMA material is affixed to the beam using techniques including those describe herein. According to some embodiments, the SMA material is affixed to a beam using adhesive film material. Ends of the SMA material, for various embodiments, are electrically and mechanically coupled with contacts configured to supply current to the SMA material using techniques including those known in the art. The contacts, according to various embodiments, are gold plated copper pads.

According to embodiments, a bimorph actuator having a length of approximately 1 millimeter are configured to generate a large stroke and push forces of 50 millinewtons (“mN”) is used as part of a lens assembly. According to some embodiments, the use of a bimorph actuator having a length greater than 1 millimeter will generate more stroke but less force that that having a length of 1 millimeter. For an embodiment, a bimorph actuator includes a 20-micrometer thick SMA material, a 20 micrometer thick insulator, such as a polyimide insulator, and a 30 micrometer thick stainless steel beam or base metal. Various embodiments include a second insulator disposed between a contact layer including the contacts and the SMA material. The second insulator is configured, according to some embodiments, to insulate the SMA material from portions of the contact layer not used as the contacts. For some embodiments, the second insulator is a covercoat layer, such a polyimide insulator. One skilled in the art would understand that other dimensions and materials could be used to meet desired design characteristics.

In some embodiments various design concepts using a cross-spring actuator are described. For example, an actuator can use a cross-spring pivot assembly. The actuator can have two or more cross-spring elements that have spring arms which cross each other at a pivot point. Further, the ends of cross-spring elements can be mechanically bonded to each other, and a crossing point can act as a pivot point during in-plane bending. SMA wires can be attached to the ends of the cross-spring elements, and can be offset from the pivot point. When SMA wires are activated in sequence, they can bend the free end of the cross-spring actuator up and down relative to the pivot point.

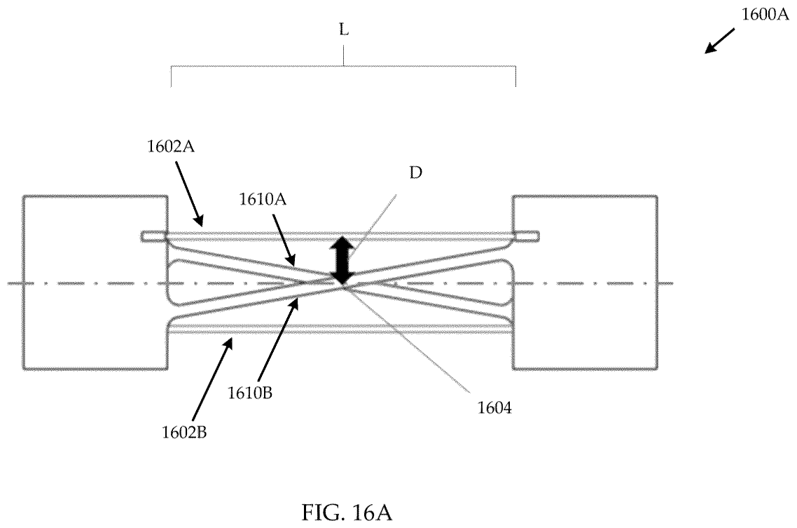

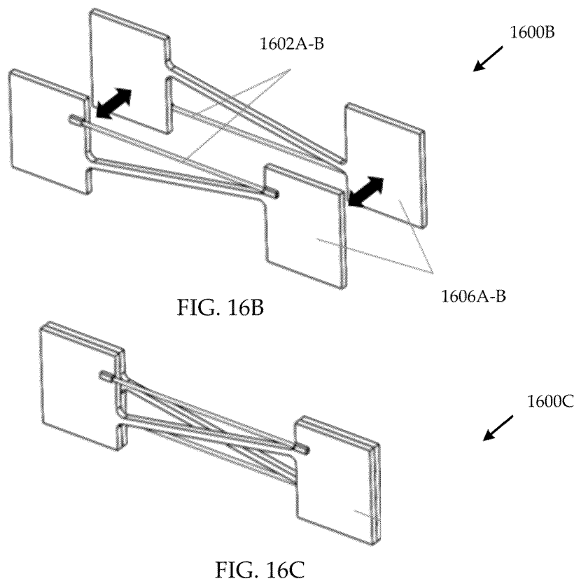

FIGS. 16A-C illustrate views 1600A-C of an example cross-spring actuator. For instance, as shown in FIG. 16A, the cross-spring actuator 1600A can include SMA wires 1602A-B that are attached a distance from a pivot point 1604 at which cross-spring arms 1610A-B cross. Further, in FIG. 16B, an exploded view 1600B of the cross-spring actuator can show SMA wires 1602A-B connected to cross-spring elements 1606A-B.

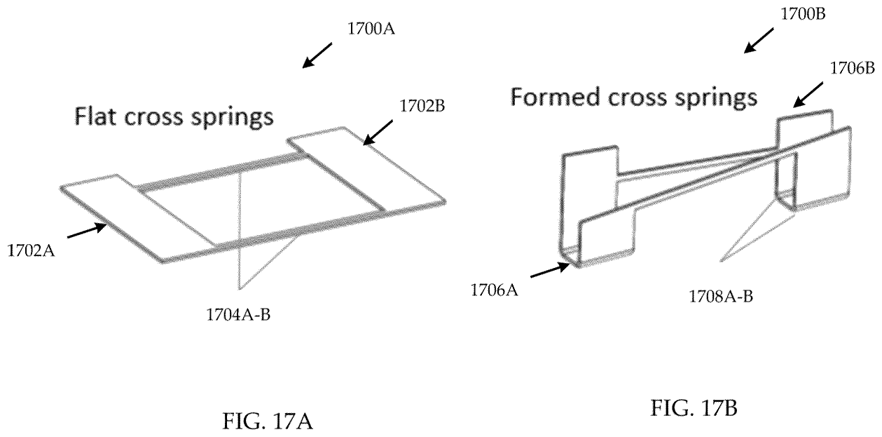

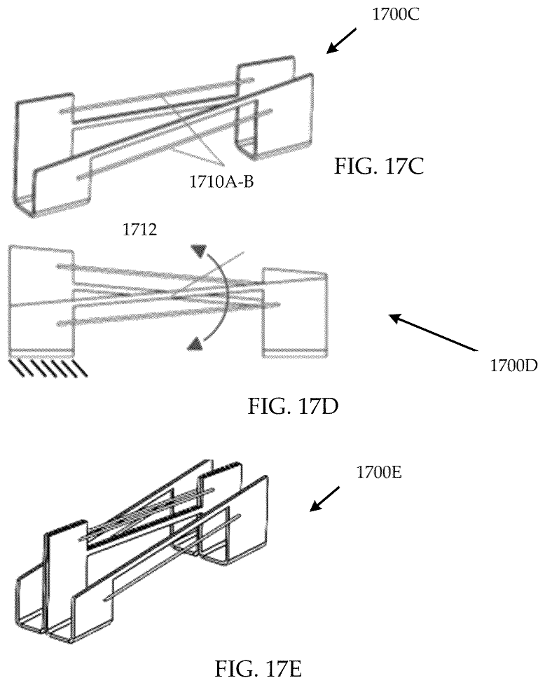

In some instances, the actuator can include a formed cross-spring actuator. This design can have both springs made from one flat piece then formed to create the cross springs. Two SMA wires can be attached to actuate the structure up and down on one end, and multiple formed cross spring pivots can be attached to each other as shown to increase rotational torque. FIGS. 17A-E illustrate views 1700A-E of an example formed cross-spring actuator. For example, in FIG. 17A, the formed cross-spring actuator can include flat cross-springs 1702A-B and spring arms 1704A-B that are parallel to one another but angled to the end sections. In another example, in FIG. 17B, the cross-springs 1706A-B can be formed, with two parallel forms 1708A-B on each formed cross-spring 1706A-B. in FIG. 17C, SMA wires 1710A-B can be attached to each cross-spring, with an effective pivot point can be where cross-spring arms cross one-another.

Many variables in a design of an actuator can impact performance in actuation. For example, any of a rotational stiffness of the cross-spring pivot, a spring length (L), a spring width (w), a spring thickness (t), a ratio of cross point length/length (a), a spring material (Modulus of Elasticity), an SMA wire distance from pivot point (D), an SMA wire length, and an SMA wire diameter can impact performance of the actuator.

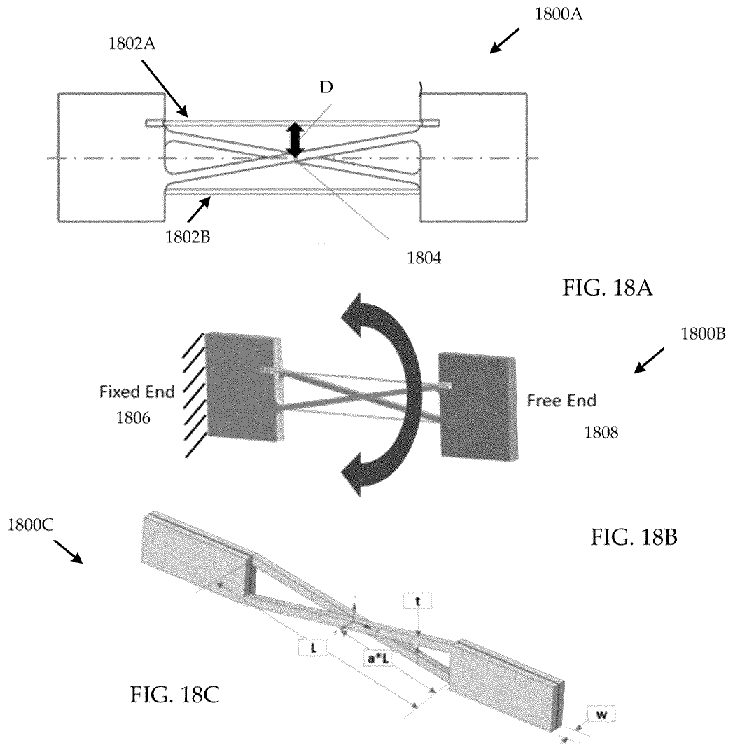

FIGS. 18A-C illustrate example views 1800A-C depicting variables of a cross-spring actuator. For example, in FIG. 18A, SMA wires 1802A-B can be attached a certain distance from a pivot point 1804 where cross-spring arms cross. The actuator can mitigate rotational movement between a fixed end 1806 and a free end 1808.

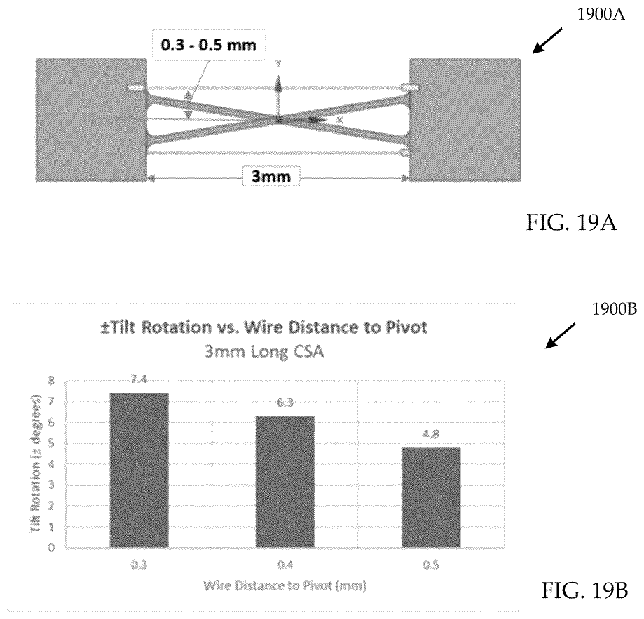

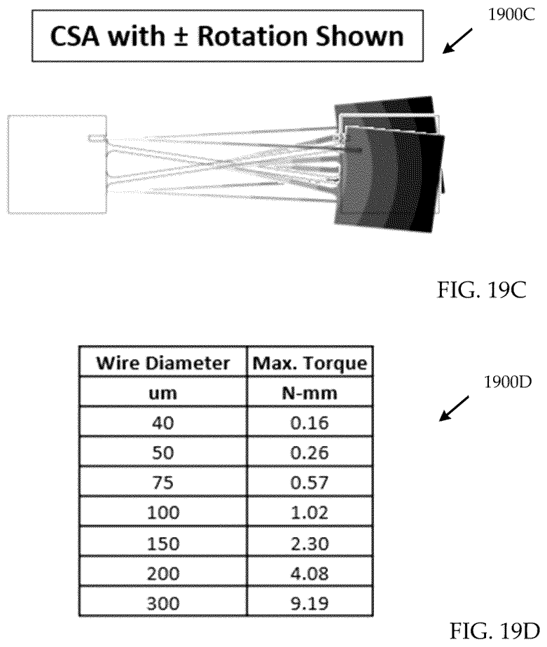

For a given design, a distance of the SMA wire to the pivot can impact the amount of rotation (e.g., ±4.8° to ±7.4°), as is represented in FIG. 19B, for example. A shorter distance can mean a larger rotation angle. A max torque can range from 0.2-9.2 N-mm and can depend on SMA wire diameter.

FIGS. 19A-D illustrate views 1900A-D of example performance characteristics for a cross-spring actuator. For example, in FIG. 19A, a distance between cross-spring elements can be around 3 mm, while a distance between a pivot point and a cross-spring arm attached to an end of the element can be around 0.3 to 0.5 mm.

In FIG. 19B, a graph 1900B can provide a graphical representation of a wire distance to pivot and a tilt rotation that can range between 7.4 and 4.8 degrees as the wire distance changes. In FIG. 19C, a rotation range of a cross-spring actuator is depicted. In FIG. 19D, a table depicting a relationship between a wire diameter (in um) and a maximum torque (in N-mm) is depicted.

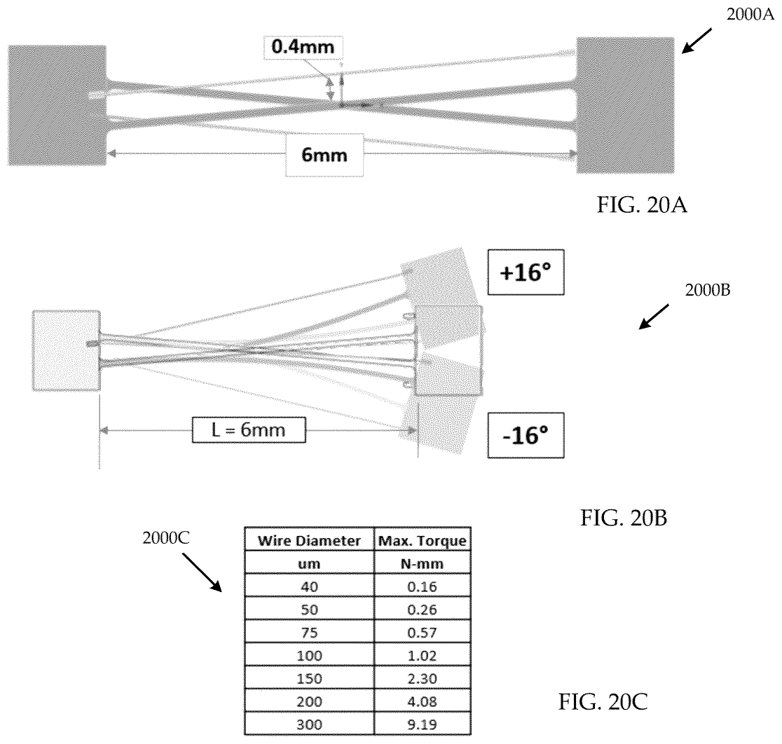

In another example, a cross-spring actuator can have a 6 mm long (L) SMA wire with a. 0.4 mm distance (D) of wire to pivot. Such a design can have a 2× length with a same wire to pivot distance and around ±16° rotation. A longer wire can allow for more rotation with the same wire distance to pivot, and a max torque can range from 0.2-9.2 N-mm and can depend on a SMA wire diameter. Torque performance can be similar to other example actuator designs, because the wire to pivot distance (0.4 mm) can be about the same in either design. Wires can be parallel to spring arms in this design, which can aid in thermal heating and cooling down length of wire. FIGS. 20A-C illustrate views 2000A-C of example actuator performance with a 6 mm length of the SMA wire.

In another example, an actuator can have a length (L) of around 60 mm (or 10X) SMA wire with a 4 mm (10X) distance (D) from wire to pivot. This design can allow for around ±18° rotation, which can be similar to 10X smaller version due to same 10X scaling of both wire length and wire to pivot distance. The 10X distance from wire to pivot can increase the torque by 10X, with a maximum torque between 2-92 N-mm depending on wire diameter. Torque can be increased with larger values of wire to pivot (D), but this can reduce rotation angles as well.

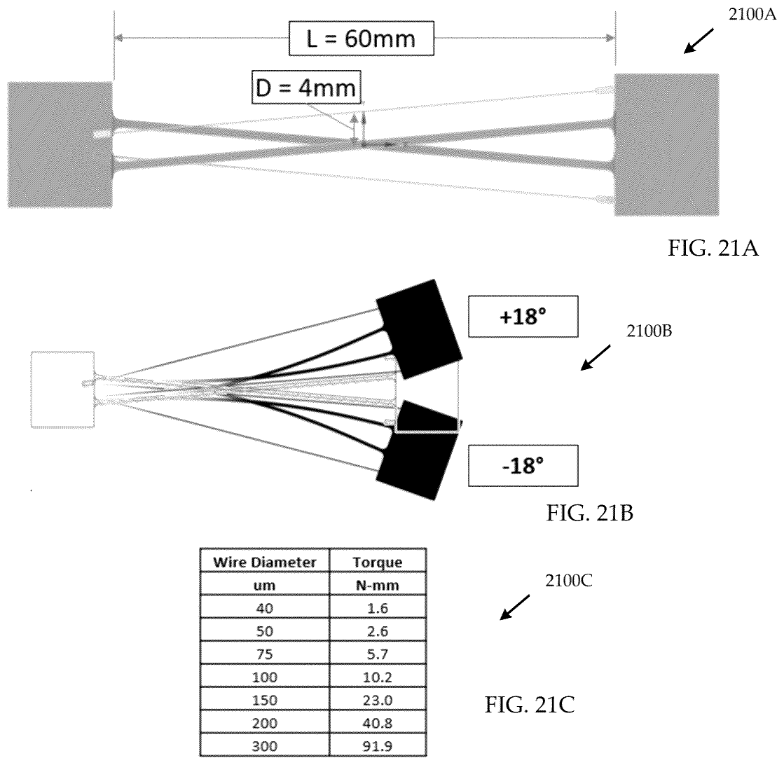

FIGS. 21A-C illustrate views 2100A-C of performance of a 10X actuator design. For example, in FIG. 21A, a length (L) can be around 60 mm, while a distance of an arm to a pivot point can be around 4 mm. In FIG. 21B, a rotation can be around plus-minus 18 degrees, and FIG. 21C is a table of an example relationship between a wire diameter and torque.

In some examples, a cross-spring actuator can use a flexible printed circuit (FPC) positioned between two cross-spring elements. The FPC can have two conductor layers, one to connect to each cross-spring element. The FPC can power the two SMA wires independently of each other and electrically isolate the two cross spring circuits from each other.

Each cross-spring element can be electrically & mechanically attached on one end and only mechanically attached to the FPC on the opposite end. An electro/mechanical bond can include solder or conductive adhesive between the cross-spring elements and the FPC. Cross-spring elements can be designed so that current can flow through a SMA wire and return through the cross-spring element. One end of the cross-spring elements can be isolated into two parts to control the flow or current across the SMA wire.

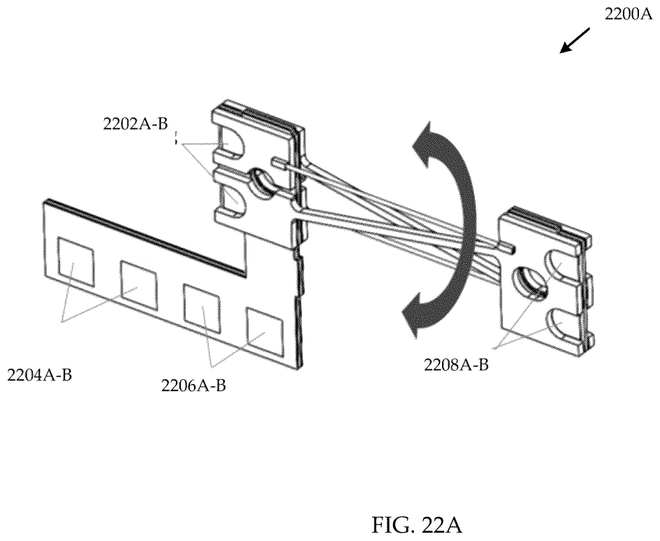

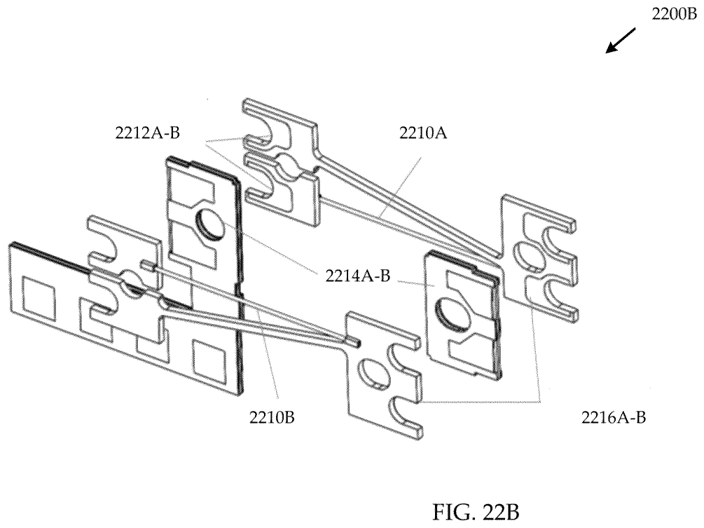

FIGS. 22A-B illustrate example views 2200A-B of a cross-spring actuator with an FPC. As shown in FIG. 22A, the actuator can include electro-mechanical bonds 2202A-B between the cross-spring element and FPC. Further, the FPC can include a first set of pads 2204A-B to control a back SMA wire (rotate downward) and a second set of pads 2206A-B to control the front SMA wire (rotate upward). The actuator can also include mechanical bonds 2208A-B disposed between the cross-spring element and the FPC. In FIG. 22B, an exploded view of the actuator, with SMA wires 2210A-B disposed between cross-spring elements (e.g., 2216A-B). The bonds 2212A-B can be isolated to control a current flow across the SMA wires. Further, an FPC 2214A-B can be disposed between cross-spring elements 2216A-B.

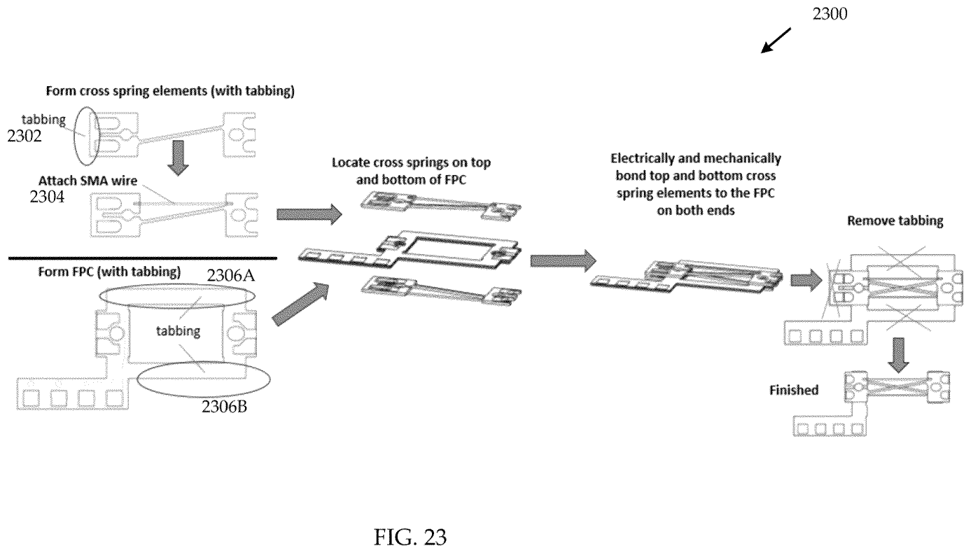

An example cross-spring actuator process flow can include forming both cross spring elements and the FPC through any of a number of methods. Both can include areas of tabbing that can aid in assembly, which can be later removed. FIG. 23 is an example flow process 2300 for manufacturing a cross-spring actuator. As shown in FIG. 23, cross-spring elements can be formed with tabbing (e.g., 2302), and an SMA wire (e.g., 2304) can be attached. The FPC can be formed with tabbing 2306A-B. The cross-springs can be located on top and bottom of the FPC, and the top and bottom of the cross-spring elements can be electrically and mechanically bonded to the FPC on both ends. The tabbing can be removed prior to completion.

In some instances, a two-direction actuator can include extra wire disposed between welds. For example, an extra SMA wire can be added to each side to allow for two-direction actuation. Without the extra wire, stroke can be lower due to stretching of the SMA wire during actuation due to the wires being located a distance away from the pivot center. For a Cross Spring design with 3 mm wire length, 30 um of extra wire can be used for maximum stroke. Cross springs could be deflected to their actuated shapes before wires are welded as a simple method of adding the extra wire.

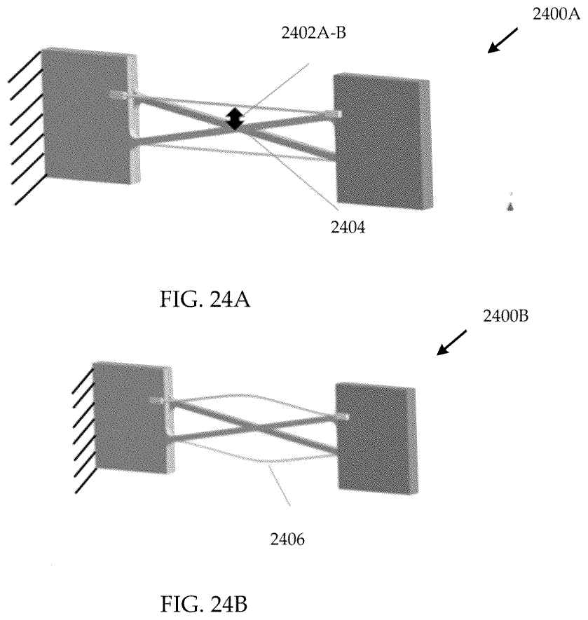

FIGS. 24A-B illustrate views 2400A-B of an example cross-spring actuator with an extra SMA wire. As shown in FIG. 21A, SMA wires 2402A-B can be attached a certain distance from a center point, such as the effective pivot point at the crossing 2404. In some instances, in FIG. 24B, an extra SMA wire 2406 can be applied between welds.

In some instances, a cross-spring actuator can be used as part of a two-axis tilt module. In such designs, four cross-spring actuators can be arranged to allow two-axis of tilt motion to a moving carriage. Two cross-spring actuators can be attached between the fixed base and the coupler on opposite sides. Power can be applied to the bottom wires to generate positive Yaw tilt and to the top wires to generate negative Yaw tilt. Two additional cross-spring actuators can be oriented 90 degrees from the other cross-spring actuators and on opposite sides from each other and attached between the Coupler and the Tilt Carriage. Power can be applied to the bottom wires to generate positive Pitch tilt and to the top wires to generate negative Pitch tilt. In some designs, magnets can be attached to the tilt carriage for sensing of tilt angle for closed loop control.

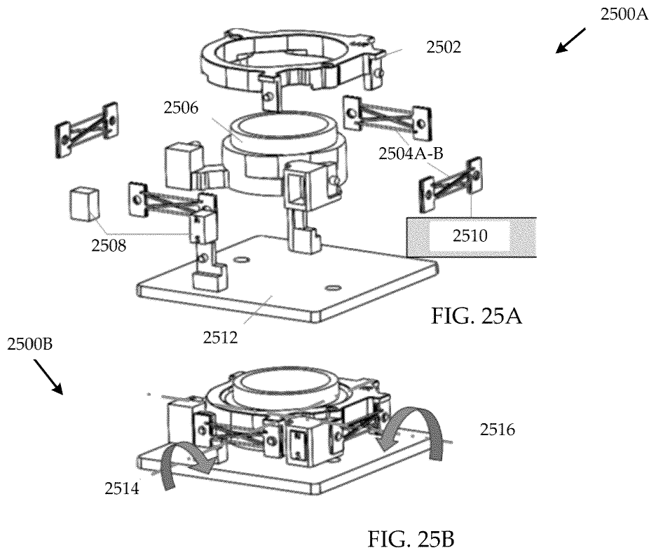

Such designs can have high tilt angles (±6° or greater), and a small footprint and thickness. FIGS. 25A-B illustrate views 2500A-B of an example two-tilt module with cross-sprint actuators. For instance, in FIG. 25A, the module 2500A can include any of a pivot coupler 2502, SMA wires 2504A-B, a tilt carriage 2506, hall magnets 2508, cross-spring actuator(s) 2510, and a fixed base 2512. In FIG. 25B, the module 2500B can be tilted on any of the yaw axis 2514 and the pitch axis 2516.

Another example design incorporating a cross-spring actuator can include a serial rotational joint. Multiple cross-spring actuators can be attached in series to increase the rotation angle of the joint. For instance, three SMA cross-spring actuators can be disposed in series to increase a rotation angle for the joint. Spacers can isolate separate circuits, and the SMA wires can be connected in series. Three SMA wires can be disposed on a front side of the joint and wired in series to pitch upward, and three SMA wires can be disposed on a back side of the joint and wired in series to pitch downward.

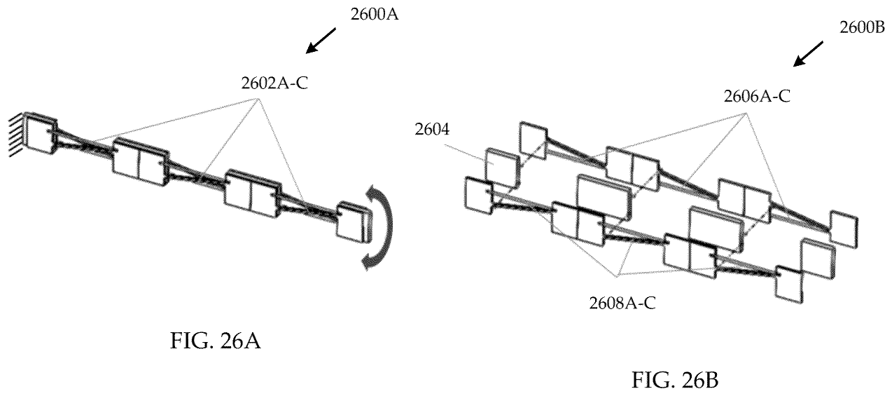

FIGS. 26A-B illustrate example serial rotational joints 2600A-B. For instance, in FIG. 26A, three cross-spring actuators 2602A-C can be connected in series. Further, in FIG. 26B, three SMA wires 2606A-C can be disposed in series to pitch down, while three SMA wires 2608A-C can be disposed in series to pitch upwards, with isolation spacers 2604 disposed between cross-spring actuators.

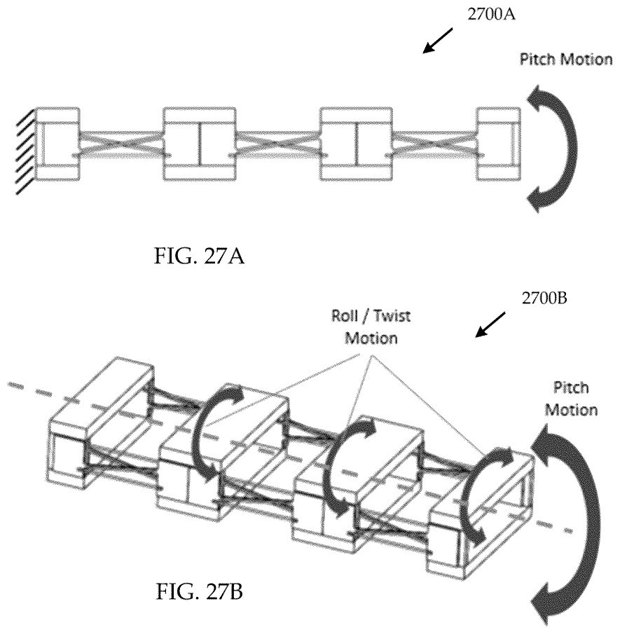

In another example design, a spine device can incorporate multiple cross-spring actuators. FIGS. 27A-B illustrate views 2700A-B of an example spine device with cross-spring actuators. Two of three series cross-spring actuators can be disposed in parallel with rigid spacers in-between creates a spine shaped actuator. A first degree of freedom can be pitch, with both parallel sides working together bending up and down and two separate circuits (e.g., an up circuit, a down circuit). FIG. 27A illustrates a view of a spine device with pitch motion.

A two-degree of freedom operation can include pitch and roll, with parallel sides that can work in-phase (pitch/bending) or can work out-of-phase (roll/twisting). Further, a spacer can be disposed to provide torsional compliance, and four separate circuits can be included (e.g., left up, left down, right up, right down). For instance, in FIG. 27B, the spine device can include roll/twist motion and pitch motion.

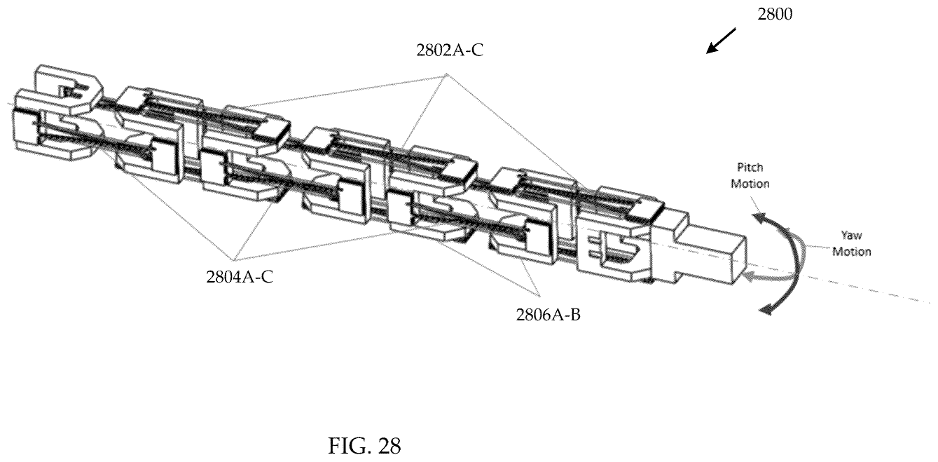

Another example design can include a two-degree of freedom (e.g., pitch, yaw) spine device with cross-spring actuator. FIG. 28 illustrates a view of an example two-degree of freedom spine device with cross-spring actuators 2800.

In such spine devices, one or more pairs of cross-spring actuators can be wired in series and placed on the sides to generate pitch motion, and one or more pairs of cross-spring actuators wired in series and placed on top and bottom to generate yaw motion. Couplers can be disposed in-between the pitch and yaw cross-spring actuator pairs which allow for the two degree of freedom motion. For instance, as shown in FIG. 28, the device can include one or more pairs of cross-spring actuators 2802A-C to create yaw motion, one or more pairs of cross-spring actuators 2804A-C to create pitch motion, and couplers 2806A-B.

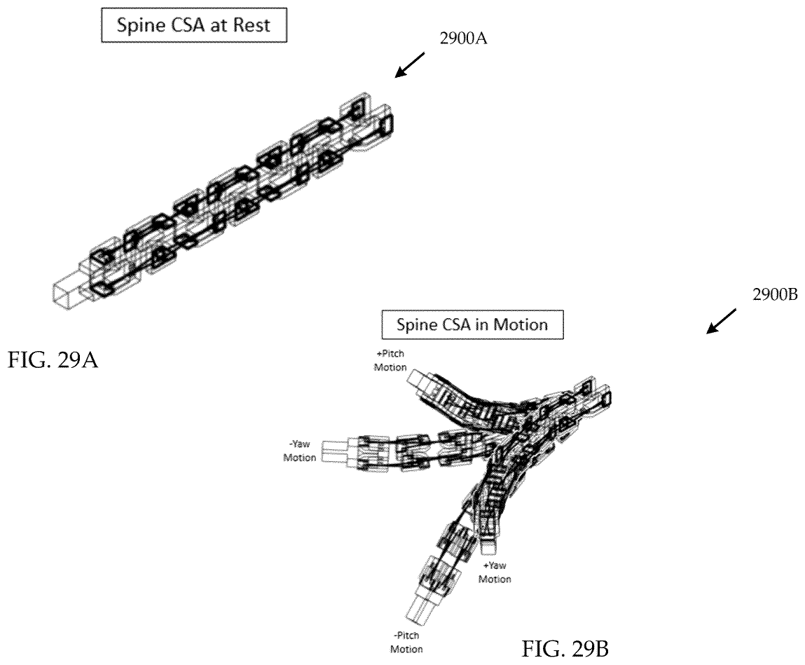

FIGS. 29A-B illustrate views 2900A-B a spine device both at rest and in motion. For instance, in FIG. 29A, the device is at rest, while in FIG. 29B, the device can be positive or negative yaw and/or pitch motion. The device can achieve plus/minus 45-degree pitch and yaw motion with three cross-spring actuators in series.

In another example design, a revolute joint can include cross-spring actuators. Three cross spring SMA actuators can be disposed in series, located about a common rotation center. Each Cross Spring Actuator (CSA) can generate ±15° of rotation. With three cross-spring actuators in series, rotation can be around ±45°. Actuators on one side can drive in positive rotation and negative rotation on the opposite side. An outer coupler can rotate at ⅓ the angle of the full motion end, and a middle coupler can rotate at ⅔ the angle of the full motion end.

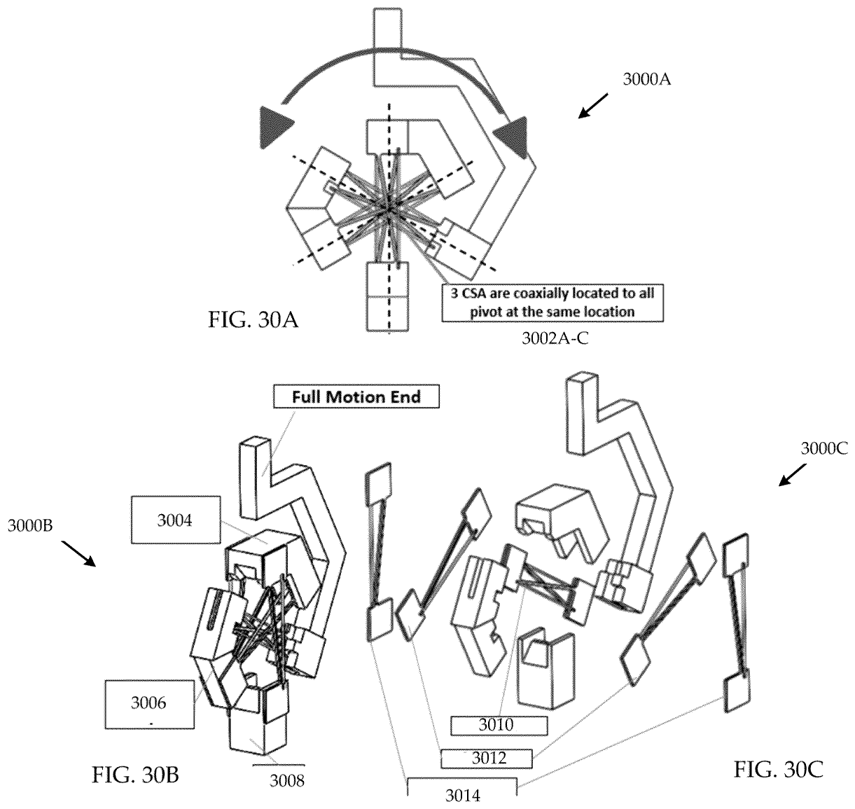

FIGS. 30A-C illustrates example views 3000A-C of a revolute joint with cross-spring actuators. As shown in FIG. 30A, three cross-spring actuators 3002A-C can be coaxially located to all pivots at a same location. Further, in FIG. 30B, an outer coupler 3004 can be disposed near a full motion end, and a middle coupler 3006 can be disposed adjacent to a base 3008. In FIG. 30C, an exploded view of the joint 3000C can depict an inner cross spring actuator 3010, middle cross spring actuator 3012, outer cross spring actuator 3014.

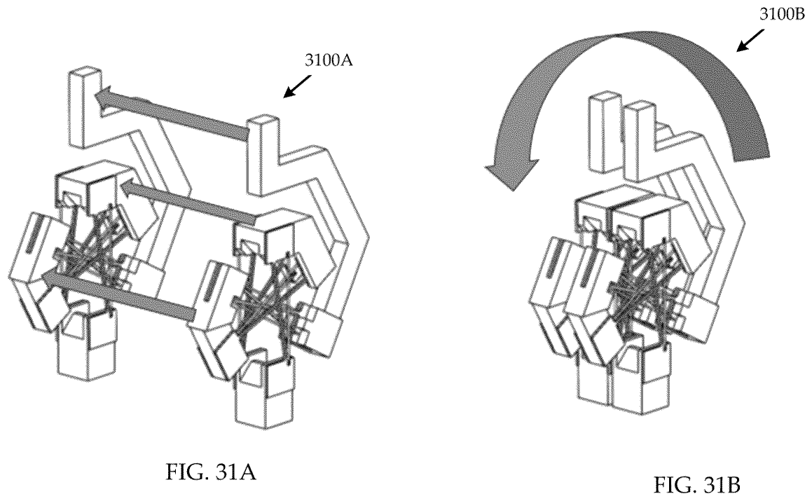

In some instances, multiple 3S revolute joints can be stacked to increase torque. FIGS. 31A-B illustrate example views 3100A-B of a stacked 3S revolute joint device. The fixed and free ends can be attached to each other as well as inner couplers for the stacked joint device.

In an example feedforward control method, two opposing SMA wires (W0 & W1) of the SMA cross spring actuator can generate opposing forces that move and rotate one end of the actuator. The SMA wires can exhibit hysteresis when switching between contraction and expansion, which can make it difficult to determine how much power to apply to each of the SMA wires to accurately control the motion. Use of a feedforward control method with a mathematical model that compensates for hysteresis of this bidirectional actuator can improve accuracy, lower power consumption, and improve reliability. This process can use a single control input of delta power to control the amount of power to the SMA wires. A Delta PWR can equal W1_PWR minus W0_PWR.

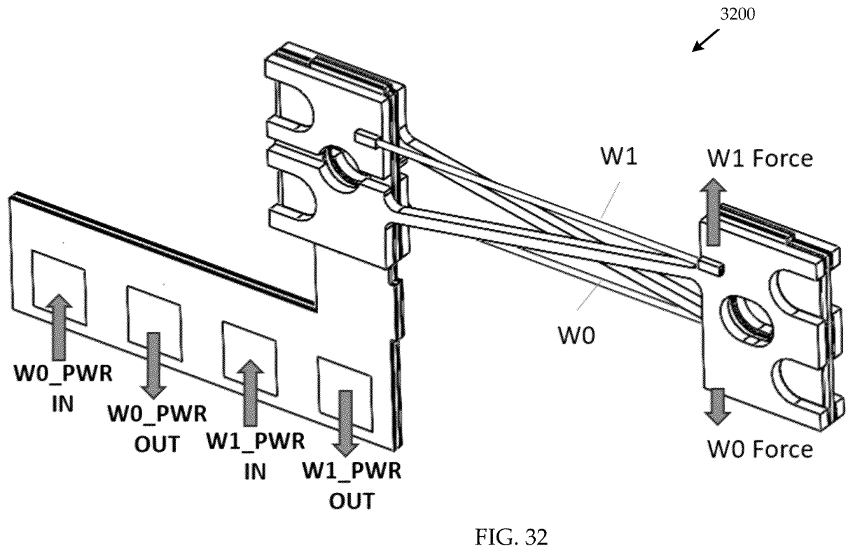

The mathematical model can adjust the delta power control input to compensate for the system hysteresis. Therefore, when a reference input of target tilt is applied, a control input of delta power can be calculated and the ideal amount of power can be supplied to the 2 SMA wires so that a linear relationship of output tilt verses input tilt is achieved. FIG. 32 illustrates an example interaction between SMA wires and power inputs and opposing forces.

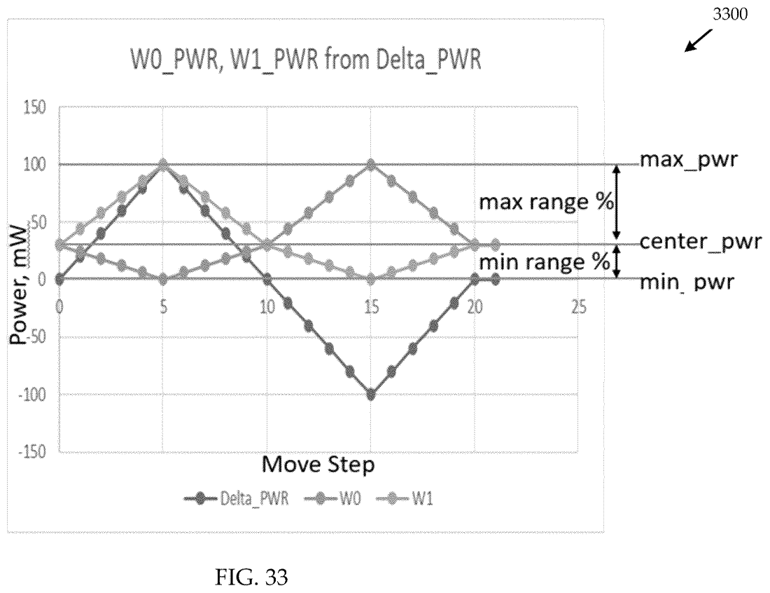

A delta power metric can be used to control opposing SMA wires. FIG. 33 is an example graphical representation 3300 of a move step and power of SMA wires in a cross-spring actuator according to some embodiments. A Delta power (PWR) can equal W1_PWR minus W0_PWR. A Min range %=(center pwr−min pwr)/(max pwr−min pwr), while a Max range %=(max pwr−center pwr)/(max pwr−min pwr).

A preset value for the metric can include a minimum power, maximum power, and a center power, where minimum power sets the lowest power to aid in cooling, maximum power is a highest power to not damage wire, and a center power sets a mid-way point of heating and cooling ramp to optimize for power consumption.

An actuator at zero tilt and under active control, both wires can be center power. If a delta power is negative, W1_PWR can equal (min range %*Delta PWR)+center power, and W0_PWR can equal W1_PWR−Delta PWR. If delta power is positive, W1_PWR can equal (max range %*Delta PWR)+center power, and W0_PWR can equal W1_PWR−Delta PWR.

In some instances, opposing SMA actuation can be controlled with feedforward control using delta power as a control input. The delta power metric as described herein can allow one metric to control the two opposing SMA wires. This metric can allow the use of available hysteresis models to achieve linear input vs. output control for this bidirectional SMA actuator.

In some cases, controlling with delta power can be the same as controlling with delta voltage or delta current since all of these are related to each other through the equation: power=voltage*current. Therefore, the current can be held constant and control using delta voltage or the voltage can be held constant and controlled with delta current. Any number of known hysteresis models can be used, such as a Preisach model, Prandtl-Ishlinskii model, Dahl model, Bouc-Wen model, etc.

The feedforward method with delta power control input can also be used together with traditional feedback control as shown to further minimize position error. This can allow for improved position control accuracy of bidirectional SMA actuator (minimized hysteresis), and lower power consumption (power to SMA wires is coordinated and optimized). Further, optimized power leads to lower stress in the SMA wires which leads to better reliability and performance, SMA wires do not fight each other, and the SMA wires can be used together with feedback control for even greater positional accuracy.

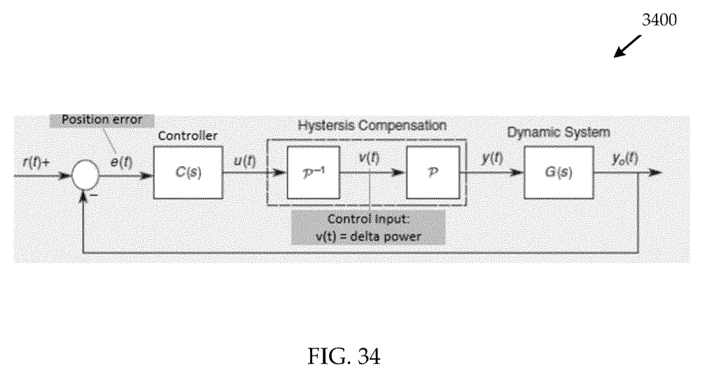

FIG. 34 is an illustration depicting an example feedforward control process 3400. As shown in FIG. 34, the process can obtain data such as a position error at a control stage to forward an output to a hysteresis compensation process that uses a control input as v(t) as equal to delta power. The output of the hysteresis compensation process can be fed to a dynamic system.

In another example embodiment, a four-wire cross-spring actuator is described. In such designs, four SMA wires can double the torque capability of the actuator. The top two SMA wires can be wired in series to rotate upward, while the bottom two SMA wires can be wired in series to rotate downward. The FPC can have two conductor layers, one to connect to each cross-spring element. The FPC can power the two pairs of SMA wires independently of each other and isolate the two cross spring circuits from each other. A center metal cross spring can be shown isolated from the SMA wires on one end so current will not flow down, and SMA wires can be bonded to the cross-spring elements using techniques such as resistance welding.

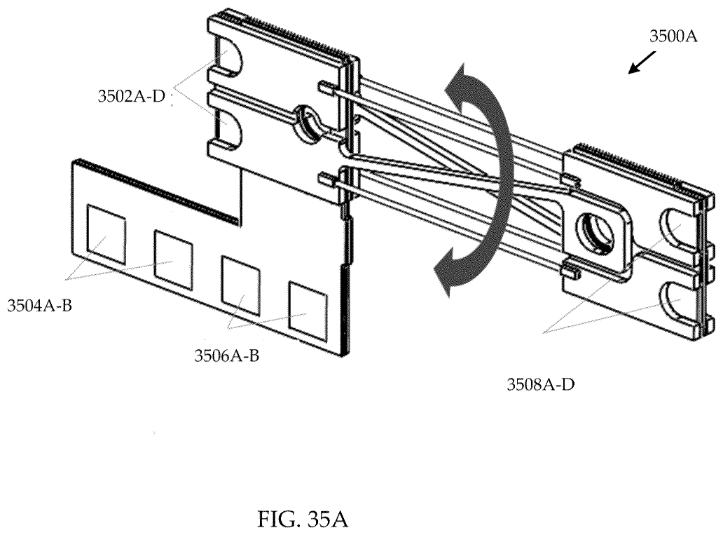

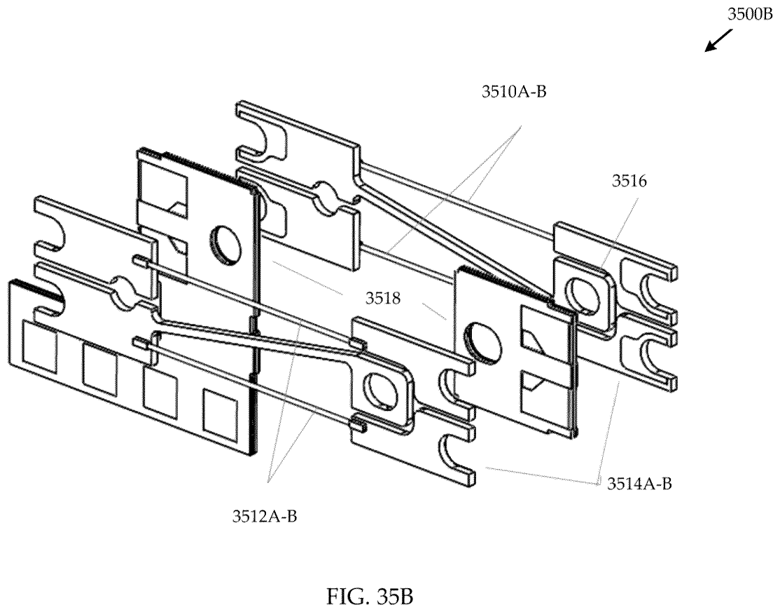

FIGS. 35A-B illustrate views 3500A-B of a four-wire cross-spring actuator. For instance, in FIG. 35A, the actuator 3500A can include four electro-mechanical bonds 3502A-D between the cross spring element and the FPC, with two pads 3504A-B to control the bottom two SMA wires to rotate downward and two pads 3506A-B to control the two top SMA wires and rotate upward. The actuator can also include four electro-mechanical bonds 3508A-D on the free end to connect the four SMA wires together. In FIG. 35B, the actuator 3500B can include any of SMA wires 3510A-B, 3512A-B, an FPC 3518, cross spring elements 3514A-B, and a cross-spring isolation element 3516 to control a current flow.

In an example embodiment, a cross-spring actuator (CSA) is provided. The CSA can include a first cross-spring element and a second cross-spring element that each have end portions, wherein end portions of each of the first cross-spring element and the second cross-spring element are a length (L) from one another. The CSA can also include a set of spring arms connecting the first cross-spring element and the second cross-spring element. The set of spring arms can be disposed at an angle such that each of the set of spring arms cross at a pivot point. The CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point. Actuation of the at least one SMA wire can cause movements of the first or second cross-spring elements relative to the pivot point.

In some instances, the first cross-spring element and the second cross-spring element are flat or comprise a pair of forms bending the first cross-spring element and the second cross-spring element.

In some instances, the distance D is between 0.3 to 0.5 millimeters (mm), and wherein a tilt rotation range of the CSA is between ±4.8 and ±7.8 degrees, and wherein a maximum torque ranges between 0.2 and 9.2 Newton millimeter (N-mm).

In some instances, the length L is around 6 mm, and the distance D is around 0.4 mm, and wherein a tilt rotation range of the CSA is around ±16 degrees, and wherein a maximum torque ranges between 0.2 and 9.2 N-mm.

In some instances, the length L is around 60 mm, and the distance D is around 4 mm, and wherein a tilt rotation range of the CSA is around ±18 degrees, and wherein a maximum torque ranges between 2 and 92 N-mm.

In some instances, the CSA can include a flexible printed circuit (FPC) disposed between portions of each of the first cross-spring element and the second cross-spring element. The FPC can include two conductive layers that are each configured to electrically connect to each portion of the first cross-spring element and the second cross-spring element. In some instances, the FPC further comprises a series of pads to provide a current to the at least one SMA wire and cause rotation of the CSA upward or downward.

In some instances, any of the first and second cross-spring elements and the FPC are formed using tabbing that is removed subsequent to forming any of the first and second cross-spring elements and the FPC.

In some instances, the CSA includes two additional SMA wires that are each disposed at each side of the CSA to allow for two-direction actuation.

In some instances, the CSA is part of a two-axis tilt module. In some instances, four CSA actuators are disposed about each side of a tilt carriage of the two-axis tilt module to allow for pitch and yaw tilting of the two-axis tilt module.

In some instances, the CSA is part of a rotational joint device where three CSA actuators are connected in series.

In some instances, the CSA is part of a spine device where two or more CSA actuators are disposed in parallel with rigid spacers disposed between adjacent CSA actuators. In some instances, the spine device comprises one degree of freedom operation with parallel sides of the two or more CSA actuators disposed in parallel bending to provide pitch motion, and wherein two separate circuits provide positive and negative pitch motion. In some instances, the spine device comprises two degrees of freedom operation with parallel sides of the two or more CSA actuators disposed in parallel bending in phase and/or out of phase to provide pitch motion and roll motion, and wherein four separate circuits provide positive and negative pitch motion and roll motion.

In some instances, the CSA is part of a revolute joint device with two or more CSA actuators are disposed in series around a rotation center. In some instances, the revolute joint device comprises an outer coupler that rotates at ⅓ an angle of a full motion end of the revolute joint device and a middle coupler that rotates at ⅔ the angle of the full motion end. In some instances, multiple revolute joint devices are disposed in parallel by attaching fixed ends and free ends of each revolute joint devices.

In some instances, at least two SMA wires are controlled via a feedforward control method. In some instances, the feedforward control method includes implementing a model that compensates for hysteresis of the SMA wires. In some instances, the feedforward control method includes using a single delta power metric comprising a difference in power provided to each of the at least two SMA wires to control the at least two SMA wires, wherein the feedforward control method uses a hysteresis model to achieve a linear input vs. output control for bi-directional control of the SMA wires.

In another example method, a method for manufacturing a cross-spring actuator includes providing a first cross-spring element and a second cross-spring element that each have end portions, wherein end portions of each of the first cross-spring element and the second cross-spring element are a length (L) from one another. The method can also include connecting a set of spring arms to the first cross-spring element and the second cross-spring element, wherein the set of spring arms are disposed at an angle such that each of the set of spring arms cross at a pivot point. The method can also include connecting at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point.

In some instances, the method can also include bending the first cross-spring element and the second cross-spring element to form a pair of forms bending the first cross-spring element and the second cross-spring element.

In some instances, the method can also include disposing a flexible printed circuit (FPC) between portions of each of the first cross-spring element and the second cross-spring element.

In some instances, the method can also include forming the first and second cross-spring elements using a first tabbing, forming the FPC using a second tabbing, and removing the first tabbing and the second tabbing.

In another example, a two-axis tilt module is provided. The two-axis tilt module includes a fixed base, a tilt carriage configured to tilt along a yaw axis and a pitch axis, and a cross-spring actuator (CSA) connected to the tilt carriage.

The CSA can include a first cross-spring element and a second cross-spring element that each have end portions, wherein end portions of each of the first cross-spring element and the second cross-spring element are a length (L) from one another. The CSA can also include a set of spring arms connecting the first cross-spring element and the second cross-spring element, wherein the set of spring arms are disposed at an angle such that each of the set of spring arms cross at a pivot point. The CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point, wherein actuation of the at least one SMA wire causes movements of the first or second cross-spring elements relative to the pivot point.

In some instances, four CSA actuators are disposed about each side of the tilt carriage of the two-axis tilt module to allow for pitch and yaw tilting of the two-axis tilt module.

In another example, a rotational joint device is provided. The rotational joint device can include at least three cross-spring actuators (CSAs) connected in series. Each CSA can include a first cross-spring element and a second cross-spring element that each have end portions, wherein end portions of each of the first cross-spring element and the second cross-spring element are a length (L) from one another. Each CSA can also include a set of spring arms connecting the first cross-spring element and the second cross-spring element, wherein the set of spring arms are disposed at an angle such that each of the set of spring arms cross at a pivot point. Each CSA can also at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point.

In some instances, spacers are disposed between the at least three CSAs to isolate separate electrical circuits.

In another example, a spine device is provided. The spine device can include two or more cross-spring actuators (CSAs) connected in parallel. Each CSA can include a first cross-spring element and a second cross-spring element that each have end portions, wherein end portions of each of the first cross-spring element and the second cross-spring element are a length (L) from one another. Each CSA can also include a set of spring arms connecting the first cross-spring element and the second cross-spring element, wherein the set of spring arms are disposed at an angle such that each of the set of spring arms cross at a pivot point. Each CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point.

The spine device can also include rigid spacers disposed between adjacent CSA actuators of the two or more CSAs.

In some instances, the spine device comprises one degree of freedom operation with parallel sides of the two or more CSA actuators disposed in parallel bending to provide pitch motion, and wherein two separate circuits provide positive and negative pitch motion.

In some instances, the spine device comprises two degrees of freedom operation with parallel sides of the two or more CSA actuators disposed in parallel bending in phase and/or out of phase to provide pitch motion and roll motion, and wherein four separate circuits provide positive and negative pitch motion and roll motion.

In another example, a revolute joint device is provided. The revolute joint device can include three CSA actuators are disposed in series around a rotation center. Each CSA can include a first cross-spring element and a second cross-spring element that each have end portions, wherein end portions of each of the first cross-spring element and the second cross-spring element are a length (L) from one another. Each CSA can also include a set of spring arms connecting the first cross-spring element and the second cross-spring element, wherein the set of spring arms are disposed at an angle such that each of the set of spring arms cross at a pivot point. Each CSA can also include at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point. Each CSA can provide around ±15 degrees of rotation.

In some instances, the revolute joint device comprises an outer coupler that rotates at ⅓ an angle of a full motion end of the revolute joint device and a middle coupler that rotates at ⅔ the angle of the full motion end.

In some instances, multiple revolute joint devices are disposed in parallel by attaching fixed ends and free ends of each revolute joint devices.

According to some embodiments, the processes described herein are used to form one or more of any of mechanical structures and electro-mechanical structures.

Although described in connection with these embodiments, those of skill in the art will recognize that changes can be made in form and detail without departing from the spirit and scope of the invention.

What is claimed is:

1. A cross-spring actuator (CSA) comprising:
a first cross-spring element and a second cross-spring element that each have end portions, wherein end portions of each of the first cross-spring element and the second cross-spring element are a length (L) from one another;
a set of spring arms connecting the end portions of the first cross-spring element and the second cross-spring element, wherein the set of spring arms are disposed at an angle such that each of the set of spring arms cross at a pivot point; and
at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point, wherein actuation of the at least one SMA wire causes movements of the first cross-spring element or the second cross-spring element relative to the pivot point.

2. The CSA of claim 1, wherein the first cross-spring element and the second cross-spring element are flat or comprise a pair of forms bending the first cross-spring element and the second cross-spring element.

3. The CSA of claim 1, wherein the distance D is between 0.3 to 0.5 millimeters (mm), and wherein a tilt rotation range of the CSA is between ±4.8 and ±7.8 degrees, and wherein a maximum torque ranges between 0.2 and 9.2 Newton millimeter (N-mm).

4. The CSA of claim 1, wherein the length L is around 6 mm, and the distance D is around. 0.4 mm, and wherein a tilt rotation range of the CSA is around ±16 degrees, and wherein a maximum torque ranges between 0.2 and 9.2 N-mm.

5. The CSA of claim 1, wherein the length L is around 60 mm, and the distance D is around 4 mm, and wherein a tilt rotation range of the CSA is around ±18 degrees, and wherein a maximum torque ranges between 2 and 92 N-mm.

6. The CSA of claim 1, further comprising:
a flexible printed circuit (FPC) disposed between portions of each of the first cross-spring element and the second cross-spring element, wherein the FPC comprises two conductive layers that are each configured to electrically connect to each portion of the first cross-spring element and the second cross-spring element.

7. The CSA of claim 6, wherein the FPC further comprises a series of pads to provide a current to the at least one SMA wire and cause rotation of the CSA upward or downward.

8. The CSA of claim 1, wherein a first SMA wire is connected to end portions of the first cross-spring element, and wherein a second SMA wire connected to end portions of the second cross-spring element.

9. The CSA of claim 8, further comprising:
two additional SMA wires that are each disposed at each side of the CSA to allow for increased torque.

10. The CSA of claim 9, wherein four CSA actuators are disposed about each side of a tilt carriage of a two-axis tilt module to allow for pitch and yaw tilting of the two-axis tilt module.

11. The CSA of claim 1, wherein the CSA is part of a rotational joint device where three CSA actuators are connected in series.

12. The CSA of claim 1, wherein the CSA is part of a spine device where two or more CSA actuators are disposed in parallel with rigid spacers disposed between adjacent CSA actuators.

13. The CSA of claim 1, wherein the CSA is part of a revolute joint device with two or more CSA actuators are disposed in series around a rotation center.

14. The CSA of claim 13, wherein CSA comprises two SMA wires, and wherein a feedforward control method for controlling a current being directed to the two SMA wires includes implementing a model that compensates for hysteresis of the SMA wires, wherein the feedforward control method includes using a single delta power metric comprising a difference in power provided to each of the at least two SMA wires to control the at least two SMA wires, wherein the feedforward control method uses a hysteresis model to achieve a linear input vs. output control for bi-directional control of the SMA wires.

15. A method for manufacturing a cross-spring actuator, the method comprising:
providing a first cross-spring element and a second cross-spring element that each have end portions, wherein end portions of each of the first cross-spring element and the second cross-spring element are a length (L) from one another;
connecting a set of spring arms to the first cross-spring element and the second cross-spring element, wherein the set of spring arms are disposed at an angle such that each of the set of spring arms cross at a pivot point; and
connecting at least one shape-memory alloy (SMA) wire that is connected at a first end at a first end portion of the first cross-spring element or the second cross-spring element and connected at a second end at a second end portion of the first cross-spring element or the second cross-spring element, wherein each of the at least one SMA wire is disposed at a distance (D) from the pivot point.

16. The method of claim 15, further comprising:
bending the first cross-spring element and the second cross-spring element to form a pair of forms bending the first cross-spring element and the second cross-spring element.

17. The method of claim 15, further comprising:
disposing a flexible printed circuit (FPC) between portions of each of the first cross-spring element and the second cross-spring element.

18. The method of claim 17, further comprising:
forming the first and second cross-spring elements using a first tabbing;
forming the FPC using a second tabbing; and
removing the first tabbing and the second tabbing.

19. A two-axis tilt module comprising:
a fixed base;
a tilt carriage configured to tilt along a yaw axis and a pitch axis; and
a cross-spring actuator (CSA) connected to the tilt carriage, the CSA comprising:
a first cross-spring element and a second cross-spring element that each have end portions, wherein end portions of each of the first cross-spring element and the second cross-spring element are a length (L) from one another;
a set of spring arms connecting the first cross-spring element and the second cross-spring element, wherein the set of spring arms are disposed at an angle such that each of the set of spring arms cross at a pivot point; and
at least one shape-memory alloy (SMA) wire that is connected at a first end at a first end portion of the first cross-spring element or the second cross-spring element and connected at a second end at a second end portion of the first cross-spring element or the second cross-spring element, wherein the at least one SMA wire is disposed at a distance (D) from the pivot point, wherein actuation of the at least one SMA wire causes movements of the first or second cross-spring elements relative to the pivot point.

20. The two-axis tilt module of claim 19, wherein four CSA actuators are disposed about each side of the tilt carriage of the two-axis tilt module to allow for pitch and yaw tilting of the two-axis tilt module.
